(19) United States
(12) Patent Application Publication
(10) Pub. No.: US 2025/0036858 A1
(43) Pub. Date: Jan. 30, 2025

(54) PERFORMING MACHINE LEARNING TECHNIQUES FOR HYPERTEXT MARKUP LANGUAGE -BASED STYLE RECOMMENDATIONS

(71) Applicant: Adobe Inc., San Jose, CA (US)

(72) Inventors: Ryan Rossi, San Jose, CA (US); Ryan Aponte, Pittsburgh, PA (US); Shunan Guo, San Jose, CA (US); Nedim Lipka, San Jose, CA (US); Jane Hoffswell, San Jose, CA (US); Chang Xiao, San Jose, CA (US); Eunyee Koh, San Jose, CA (US); Yeuk-yin Chan, San Jose, CA (US)

(73) Assignee: Adobe Inc., San Jose, CA (US)

(21) Appl. No.: 18/225,906

(22) Filed: Jul. 25, 2023

(51) Int. Cl. G06F 40/154; G06F 40/117; G06F 40/143

(52) U.S. Cl. CPC G06F 40/154; G06F 40/117; G06F 40/143

(57) ABSTRACT

Techniques discussed herein generally relate to applying machine-learning techniques to design documents to determine relationships among the different style elements within the document. In one example, hypergraph model is trained on a corpus of hypertext markup language (HTML) documents. The trained model is utilized to identifying one or more candidate style elements for a candidate fragment and/or a candidate fragment. Each of the candidates are scored, and at least a portion of the scored candidates are presented as design options for generating a new document.

### BACKGROUND

Designing graphical documents, such as those utilized in email marketing campaigns, posters, or other marketing material is typically very time-consuming, requiring a lot of manual effort, and therefore very costly to design high quality and effective designs for the campaigns. There are some tools that try to make this process easier and faster. However, they all have many fundamental limitations. For instance, there are some templates that can be used, but the number of these are very limited, and are often not suitable for a specialized marketing campaign being designed by a designer, while also being difficult to customize. Some other work has focused on using manually defined rules to suggest design features, such as alternative font-colors or background-color for different components of a document. For example, there may be a manually defined rule by some expert that says if a button background-color is black, then we should recommend a certain background-color that contrasts with the button. Obviously, such an approach does not scale, is costly to maintain, requiring a lot of manual effort to write such rules, while also being costly as it requires experts and expert knowledge to define such rules. Furthermore, the suggestions by this approach are very limited, and are often obvious to designers, and thus limited in their utility in the design process. Embodiments discussed herein are directed to solving these and other problems.

### BRIEF SUMMARY

Embodiments are generally directed to extending artificial intelligence and machine learning techniques to provide design suggestions during the creation of a document, such as a HyperText Markup Language (HTML) document including textual and graphical elements, for example. Specifically, embodiments are directed to a machine-learning based approach that learns to provide design suggestions by leveraging and processing previously created documents to identify high quality design styles. For example, some embodiments utilize a hypergraph neural network framework and learning a model on a large set of documents including various design elements to provide design suggestions efficiently and accurately to the creation of new documents.

Any of the above embodiments may be implemented as instructions stored on a non-transitory computer-readable storage medium and/or embodied as an apparatus with a memory and a processor performs the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system 100 in accordance with embodiments discussed herein.

FIG. 2A and FIG. 2B illustrate an example of a processing flow 200 in accordance with embodiments.

FIG. 3 illustrates an example of a processing flow 300 in accordance with embodiments.

FIG. 4 illustrates an example of a processing flow 400 in accordance with embodiments.

FIG. 5 illustrates an aspect of the subject matter in accordance with one embodiment.

FIG. 6 illustrates an aspect of the subject matter in accordance with one embodiment.

FIG. 7A illustrates an aspect of the subject matter in accordance with one embodiment.

FIG. 7B illustrates an aspect of the subject matter in accordance with one embodiment.

FIG. 8 illustrates a routine 800 in accordance with one embodiment.

FIG. 9 illustrates a routine 900 in accordance with one embodiment.

FIG. 10 illustrates a routine 1000 in accordance with one embodiment.

FIG. 11 illustrates an aspect of the subject matter in accordance with one embodiment.

FIG. 12 illustrates a system 1200 in accordance with one embodiment.

FIG. 13 illustrates an apparatus 1300 in accordance with one embodiment.

FIG. 14 illustrates an artificial intelligence architecture 1400 in accordance with one embodiment.

FIG. 15 illustrates an artificial neural network 1500 in accordance with one embodiment.

FIG. 16 illustrates a computer-readable storage medium 1602 in accordance with one embodiment.

FIG. 17 illustrates a computing architecture 1700 in accordance with one embodiment.

FIG. 18 illustrates a communications architecture 1800 in accordance with one embodiment.

### GLOSSARY OF TERMS

“Candidate fragment” refers to a recommended or suggested fragment for a document.

“Corpus” refers to a collection of works or documents, e.g., HTML document.

“Fragment” refers to a section of a document.

“Fragment edge” refers to a boundary of a fragment with another fragment.

“Hardware” refers to computing hardware.

“HTML document” refers to HyperText Markup Language (HTML document) or any document with textual or graphical designs.

“Hyperedge” refers to a generalization of an edge in graph theory. A hyperedge can connect any number of vertices or nodes.

“Hypergraph” refers to a generalization of a graph in which a hyperedge can connect any number of vertices or nodes.

“Matrix” refers to a matrix that represents a hypergraph.

“Model” refers to a framework incorporating multi-modal data and data correlations.

“Neighboring fragment” refers to a fragment neighboring another fragment.

“Node” refers to a vertex that can have multiple types.

“Candidate style element” refers to a style element recommendation.

“Style element” refers to an element in a document.

“Vector representations” refers to representing a piece of data as a vector.

### DETAILED DESCRIPTION

Embodiments are generally directed to a machine learning based approach that learns to recommend high-quality design styles by leveraging a large corpus of documents, such as HTML-based documents, among others. In one example, a training system trains a machine learning model using a large corpus of HTML-based design documents, such as those found in HTML-based emails, websites, posters, slides, etc. Given the large corpus of HTML documents, the training system decomposes each of the documents into a sequence of high-level fragments. More particularly, the training system decomposes each of the fragments into a set of style or design elements, such as buttons, button-text, button-style, background-color, font-color, and more generally background-style and font-style, as well as images and text such as title, subtitle and so on.

Embodiments utilize a hypergraph framework to encode the fragments as hyperedges in a hypergraph, and the style entities as nodes within each hyperedge. In embodiments, the training system determines vector representations of the relationships between the fragments and style elements and generates a hypergraph neural network. The training system trains a model from the hypergraph derived from the large corpus of HTML emails that captures the similarity between the different HTML fragments, and the higher-order relationships between the individual style and design elements of the fragments.

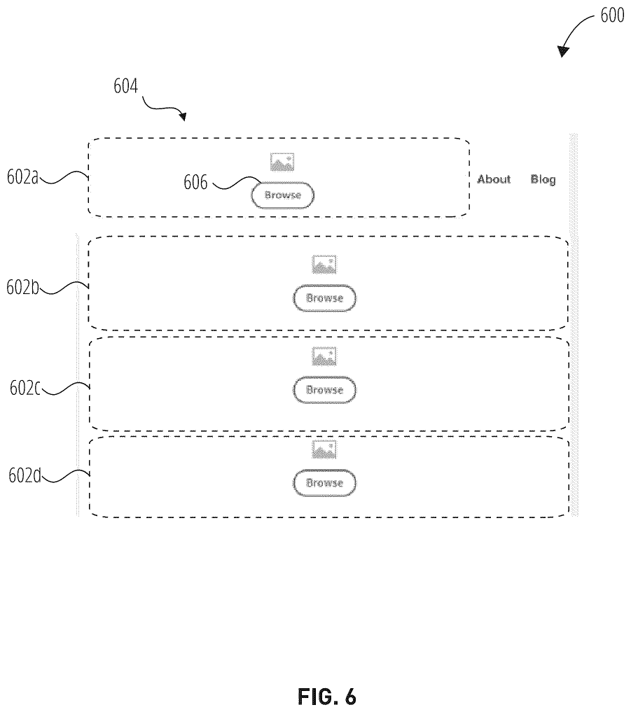

In embodiments, the ML-based approach is useful for providing recommendations for entire design styles. The entire design of an HTML email fragment includes the background and characteristics of each style element, e.g., font-color and style, button-style, text, font and background-color of a button, and so on. Previous approaches generally relied upon a simple rule-based approach that can only recommend different colors or background-color and not entire fragments. Embodiments discussed herein can make complex recommendations since the training system encode the entire fragment as a hyperedge along with its style and represent the design elements as nodes within the hyperedge. Thus, the approach can recommend entire fragments by solving a hyperedge prediction task since hyperedges naturally encode the set of design styles and elements of a fragment. Further, such fragments do not need to be present in the training set, and thus the approach is naturally inductive in the sense that it can be used to infer the quality of any unseen hyperedge in the future (FIG. 6). This is another important advantage of the approach compared to the rule-based method that requires expert knowledge and is only able to use known style rules, which are very few since it is costly and time-consuming for an expert to come up with them, and even more so to keep them updated.

Embodiments also provide recommendations for individual style elements. Specifically, systems discussed herein can directly score individual style and design elements (such as the background-color of a button) along with an entire HTML fragment, and any HTML document in general. Thus, embodiments also enable users to complete existing designs that have been partially specified or designed. For instance, if a background-color of a fragment is specified, then solutions discussed herein automatically complete the remaining style and design elements for that fragment. In some instances, the system enables a user to pick a design from a list of options. For example, the system also displays a ranked list of a few top choices of completed fragments. These and other details will be discussed in the following description.

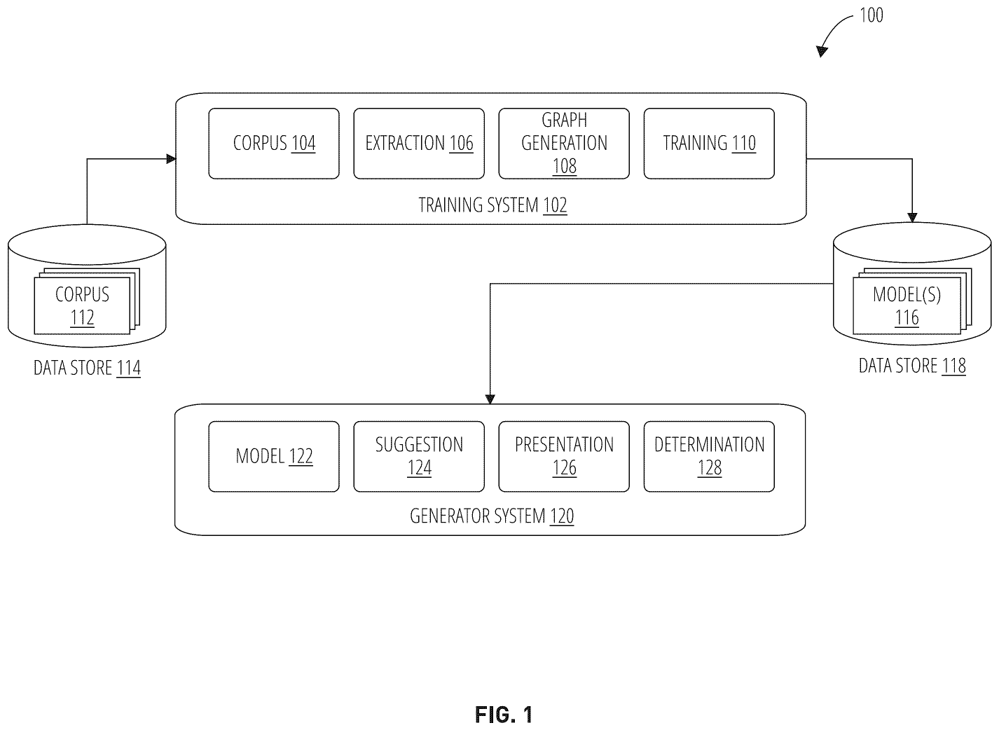

FIG. 1 illustrates an example embodiment of a system 100 performs the operations discussed herein. The system 100 includes additional systems, and computing components to perform various operations. In one example, the system 100 includes a training system 102 including components or modules perform training operations. These modules include a corpus module 104, an extraction module 106, a graph generation module 108, and a training module 110. Each of the modules performs one or more operations to process a large corpus of training data, and learn or train at least one model.

In various embodiments, the training system 102 implements a machine learning based approach that learns to recommend high-quality design styles by leveraging a large corpus 112 of documents. The documents include HTML-based documents, such as HTML emails, HTML websites, HTML posters, HTML slides, etc. In one example, the corpus module 104 retrieves a corpus 112 from a data store 114 for processing by the training system 102. For example, these documents are stored in a data store 114 hosted by a third-party system, such as a cloud-based storage system. In one example, the HTML documents are a publicly available collection of HTML design email documents stored in a data store 114 of a third-party system. Alternatively, the documents are private documents stored locally or remotely on a first-party system, e.g., owned or controlled by the entity performing the training.

In embodiments, the extraction module 106 processes the documents. For example, the extraction module 106 breaks each document into different fragments utilizing one or more detection techniques. The extraction module 106, given the large corpus of HTML documents, decomposes each of the documents into fragments and style elements. Each of the HTML documents includes a sequence of high-level fragments, which, in some instances, are HTML fragments or blocks that define a stylistic component of each document. The extraction module 106 extracts each fragment and determines each style element within or associated with each fragment. In some instances, to ensure spatial dependencies, the extraction module 106 decomposes each document in a sequence based on location since the fragment's styles often depend on other fragments near one another in the HTML document, e.g., neighboring fragments. The extraction module 106 also extracts style and design elements from each of the fragments. The style elements include buttons, button-text, button-style, background-color, font-color, and more generally background-style and font-style, as well as images and text such as title, subtitle, and so on.

These fragments and style elements are processed with hypergraph modeling techniques to discover relationships between the fragments and style elements. A hypergraph is a generalization of a graph structure that allows for edges (also called hyperedges) to connect more than two vertices (nodes or hypernodes). In a traditional graph, edges connect pairs of vertices, while in a hypergraph, hyperedges can connect any number of vertices.

Formally, a hypergraph includes a set of vertices and a set of hyperedges, where each hyperedge is a subset of the vertex set. For example, if we have vertices {A, B, C, D, E}, a hypergraph can have hyperedges like {A, B, C}, {B, D, E}, or even {A, B, C, D, E}.

Hypergraphs can be represented visually by drawing vertices as points and hyperedges as curves or lines connecting multiple vertices. However, since hyperedges can connect more than two vertices, they are often depicted as sets of vertices enclosed in brackets or curves.

Hypergraphs find applications in various fields, including computer science, mathematics, social network analysis, and data mining. They provide a flexible and powerful representation for modeling relationships that involve more than pairwise connections. As discussed herein, hypergraphs are great for identifying relationships in design drawings.

In embodiments, the system 100 includes a graph generation module 108, utilizing a hypergraph framework to encode the fragments as hyperedges in a hypergraph and the style element as entities or nodes of the hypergraph. In embodiments, the graph generation module 108 includes each style element from a particular fragment within the hyperedge generated for the particular fragment to capture relationships between style elements within the same fragment. Also, the graph generation module 108 generates the hypergraph with overlap between the different hyperedges of the hypergraph to capture relationships between elements in different fragments and among the fragments. The training module 110 then trains a model on the hypergraph neural network that captures the similarities between the different HTML fragments, and the higher-order relationships between the individual style and design elements of the fragments (hyperedges). The training module 110 outputs a trained model 116 and stores the model 116 in a data store 118.

In embodiments, the training module 110 learns both individual embeddings of the nodes (entities) along with an embedding for each HTML fragment (hyperedge). In one example, the training module 110 derives a function over individual node embeddings from obtaining the overall embedding for that fragment. Learning individual embeddings of the nodes (entities) and embedding for each HTML fragment (hyperedge) contextualizes them. Contextualizing the embeddings is important to score new unseen HTML fragments that are likely to be of interest to a designer, e.g., provided as recommendations. A generator system 120 provides suggestions with the highest probability of being relevant/important to a design even when those HTML fragments do not appear in the training corpus 112.

In embodiments, the generator system 120 implements one or more of the models 116 to perform inferencing operations to make suggestions or recommendations during the design process of a new or existing HTML document, such as a new HTML email, poster, webpage, etc. In one example, the generator system 120, including its modules, the model module 122, the style suggestion module 124, presentation module 126, and determination module 128 performs various operations to generate suggestions and help a user generate a design document. This process includes suggestions for entirely new fragments suitable for a given document or an element for a partially designed fragment. In one embodiment, for example, the generator system 120 utilizes the ML-based approach for recommending entire design styles, e.g., the entire design of an HTML email fragment, including the background and font-color of the fragment and its style, along with the button-style, text, font-color, and background-color of the button, and so on.

In embodiments, the generator system 120 includes a model module 122. The model module 122 retrieves a model from the data store 118. In one example, the model module 122 retrieves the model based on the document design type, e.g., HTML email, HTML poster, HTML webpage, etc. As previously discussed, the model is a hypergraph neural network previously trained on a corpus of HTML documents to recognize relationships between fragments and style elements. The model is stored in a data store in a data structure, such as a multidimensional matrix.

The generator system 120 further includes a style suggestion module 124 to generate a new fragment or element for a fragment that is presented to a user as a recommendation. In one example, the style suggestion module 124 solves a hyperedge prediction task to determine a recommendation for a fragment since the hyperedges encode the set of design styles and elements of a fragment. In another example, the style suggestion module 124 generates recommendations of particular elements, such as colors (background and font-colors), buttons, text, and so on, even before the user has specified these entities (colors, buttons, . . . ). The style suggestion module 124 supports next-color/button/background recommendations and, in general, next-fragment recommendations by directly scoring individual style and design elements (such as the background-color of a button) and/or an entire HTML fragment representing a set of these elements.

Embodiments further include completing an existing design a user has partially specified or designed. For instance, suppose a user specifies a background-color of a fragment, the style suggestion module 124 automatically completes the remaining style and design elements for that fragment. In some instances, the style suggestion module 124 provides a number of options for a user to choose from for each of the style elements. In one example, the style suggestion module 124 displays to the user a ranked list of one or more of the top choices of completed fragments based on an initial selection.

The generator system 120 further includes a presentation module 126 to present one or more style element recommendations to a user via a graphical user interface (GUI). In one example, the presentation module 126 displays a single suggestion for a style element for a fragment, the suggested style element having the highest score based on scoring. In another example, the presentation module 126 displays a list of recommendations, which, in some cases, is a ranked list based on the scoring.

In embodiments, the generator system 120 includes a determination module 128 to process a style element recommendation and a user determination. In some instances, the determination module 128 processes a user selection of one of the one or more recommendations provided to the user for a specific style element, e.g., a white background. The determination module 128 generates an HTML document based on one or more user selections of a fragment and/or one or more style elements. These and other details are discussed in the following description and processing flows.

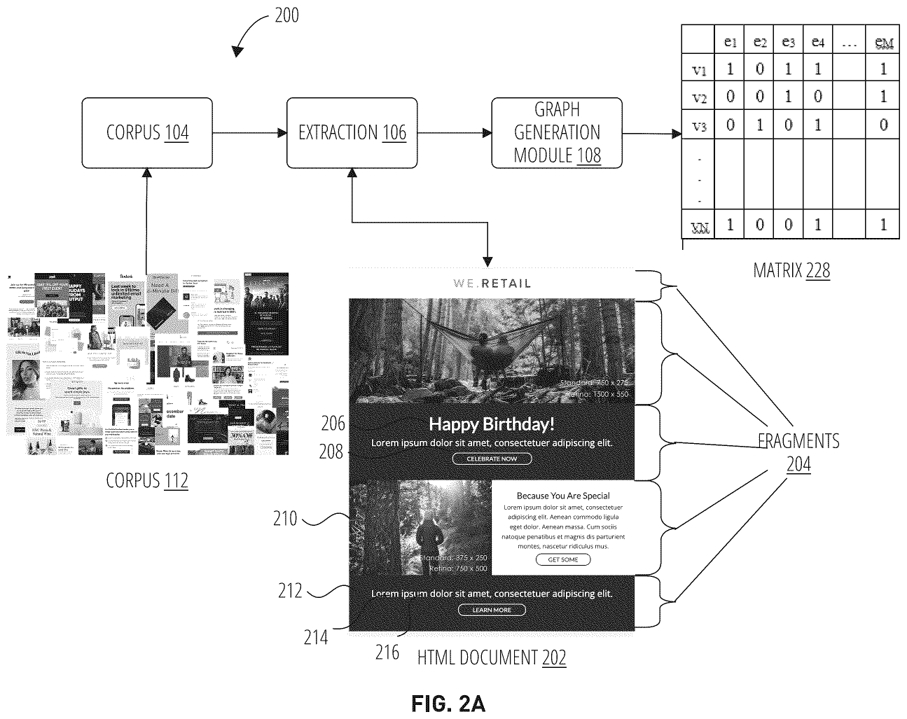

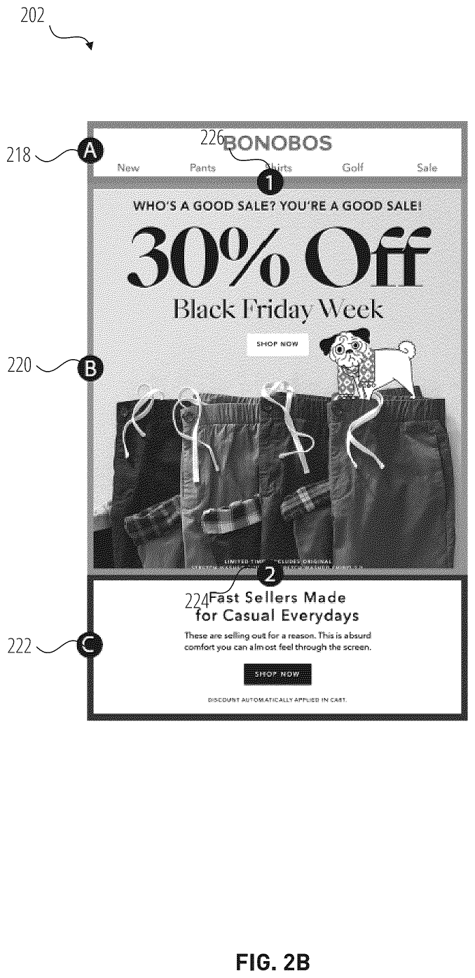

FIG. 2A illustrates a detailed example of a processing flow 200 to process a corpus and perform a data extraction. In the FIG. 2A, the corpus module 104 collects a large corpus 112 of HTML documents. In one example, the corpus module 104 obtains the corpus 112 from an online database source storing the corpus 112. In other instances, the corpus module 104 retrieves the corpus 112 from a local data store and embodiments are not limited in this manner. The corpus 112 includes many HTML documents to sufficiently train the model. In one example, the corpus 112 includes at least thousands of HTML documents of previously designed emails, posters, websites, etc. However, embodiments are not limited to a particular size of a corpus.

Each HTML document includes one or more fragments, and each of the fragments includes one or more style elements. Thus, each HTML document has tens of fragments, and each fragment includes tens of style elements, while the total corpus 112 has tens of thousands of fragments and even more style elements.

In embodiments, each of the style elements is one of a style element type. In one example, there are only several style element types, including a button-style, a text-style, a word, a background-font, a background-style, and an image. Each of the style elements is one of these style element types and is represented as a node in the hypergraph. The hypergraph further includes a node for each fragment in the corpus to capture the spatial relationship between each fragment.

The corpus module 104 provides the corpus 112 to the extraction module 106, and the extraction module 106 extracts fragments and style elements for each of the HTML documents. FIG. 2A illustrates one example HTML document 202 and its different parts, including a number of fragments 204. In the example HTML document 202, each of the fragments 204 includes style elements, including a font style 206 for text, a button style 208 for a button, an image 210, a background-style 212 for a fragment, a font-color 214 for a font, and words 216. Note that HTML document 202 includes additional style elements, and the highlighted ones are for illustrative purposes.

In one example embodiment, the extraction module 106 idenifies the fragments and style elements of an HTML document utilizing HTML tags. The HTML tags are used to define the structure and content of an HTML document. One example HTML tag includes the <div> tag that is used to create sections (fragments) of an HTML document, such as a header, footer, or sidebar. The extraction module 106 identifies each fragment via the <div> tag. Other HTML tags the extraction module 106 utilizes to identify a fragment include the <head> tag to identify the header section of an HTML document, the <title> tag to identify the title, and the <body> tag to identify the body section of the HTML document. Embodiments are not limited in this manner.

The extraction module 106 also utilizes different HTML tags to identify the style elements. Example HTML tags used to identify style elements include the <IMG> tag to identify an image, the <Button> tag to identify a button, the <style> tag to identify a text style, the <figure> tag to identify a figure, a <b> tag to identify bold text, an <i> tag to identify italic text, and so forth.

The extraction module 106 also identifies style elements utilizing a style attribute. For example, the background color or style is identified as red by the extraction module 106 identifying the code <element style=“background-color: red;”>. In another example, the extraction module 106 identifies a font color or style by a similar style code, e.g., <element style=“color: red;”>. In addition to the <i> italic tag, the extraction module 106 is also identifies font styles based on element style attribute, e.g., <element style=“font-style: italic;”>. Additional styles the extraction module 106 identifies include, but are not limited to, the color of the text, the background color of the element, the size of the font, the family of the font, the weight of the font, the alignment of the text, the decoration of the text, the border of the element or fragment, the margin of the element or fragment, the padding of the element, etc. Table 2 illustrates additional example style element types identifiable by the extraction module 106.

TABLE 2

| Entity-Type | Example |
|---|---|
| button-style | bg-color: #3867FF; border-radius: 50px; |
| | color: #FFF; font-size: 16px; |
| bg-style + font | bg-color: #DB2100; color: #FFF; |
| text-style | font-size: 12px; color: #7C7C7C; |
| background | bg-color: #fafafa; bg-image: . . . ; |
| style | bg-repeat: no-repeat; bg-size: cover |
| entire fragment | — |
| words | connected, enjoy, favorite, . . . |
| image | actual image |

In addition to capturing fragments and style elements for each fragment, the extraction module 106 identifies the spatial relationship present between fragments in the HTML document. As mentioned, the extraction module 106 includes a node for each fragment and a hyperedge connecting each fragment to the fragment immediately below or beside it. The extraction module 106 utilizes the nodes for the fragments to capture the sequence of such fragments.

FIG. 2B illustrates an example of an HTML document 202 with fragments that border each other, and each of the fragments have a plurality of style elements. As mentioned, two fragments bordering each other are related, and their styles are complementary. To ensure these dependencies are encoded during model training and capture spatial relationships, the extraction module 106 adds a node that is included in all the fragments that border one another. For instance, in the above example, there are three fragments (hyperedges) denoted 218(A), 220(B), and 222(C); and the extraction module 106 encodes the spatial relationship adding two nodes denoted 226(1) and 224(2). These nodes 226 and 224 are a combination of A-B and B-C. Hence, the hyperedges bordering one another will share at least one node between them.

With reference back to FIG. 2A, the processing flow 200 also includes storing the extracted data from the HTML documents in a data structure such that when the data is recalled, a hypergraph including the hyperedges and nodes can be generated or regenerated. In one example, the graph generation module 108 receives or retrieves the extracted data from the extraction module 106, i.e., the fragments and style elements, and stores the data in a matrix 228. In one example, the matrix 228 is an incidence matrix where each vertex in the hypergraph is represented by a row in the matrix. The columns of the matrix represent the hyperedges in the hypergraph. Further, the cells include indications as whether a relationship exists between the hyperedges and vertices (hypernodes). For example, a one (1) in a cell indicates that the vertex is connected to the hyperedge, and a zero (0) indicates that it is not. In some instances, a vertex represents a style element, and in other instances, avertex represents a style element type, and another dimension of the matrix stores the attribute for a particular style element type.

Embodiments are not limited to storing the extracted data in an incidence matrix. In other instances, the data is stored by the graph generation module 108 in an adjacency list where each vertex in the hypergraph is represented by a list of its neighbors. The neighbors can be other vertices, hyperedges, or both. In a third example, the data is stored in a resource description framework (RDF) triplestore, where each vertex in the hypergraph is represented by a subject, a predicate, and an object. The subject is the vertex, the predicate is the relationship between the vertex and another vertex or hyperedge, and the object is the other vertex or hyperedge.

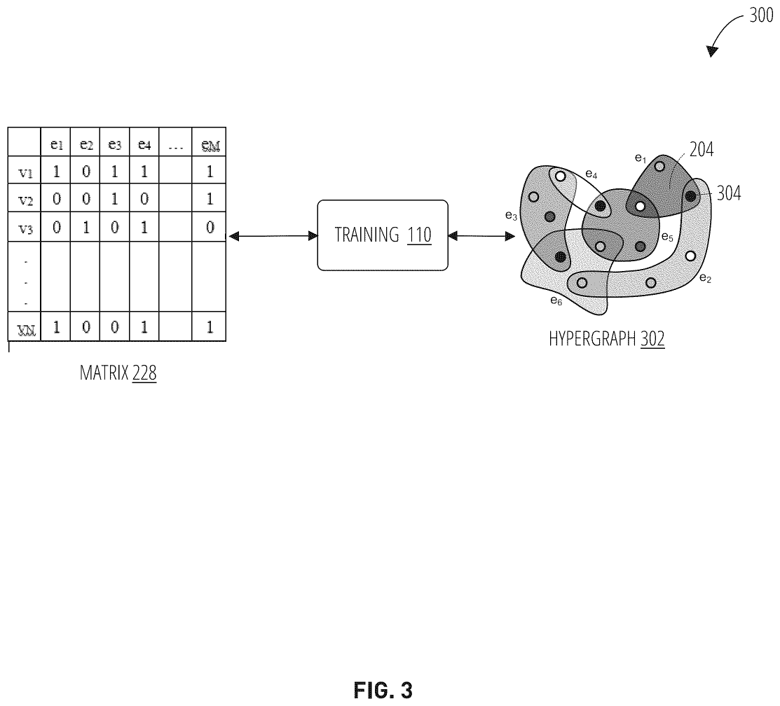

In embodiments, the data is utilized to train a model by the training module 110. As illustrated in FIG. 3, the training module 110 utilizes the data in the data structure or matrix 228 to learn or train on the hypergraph 302. The following is a detailed description of one possible example of a model and training. In one example, the model is a learning-based model, where G=(V, E) denotes a hypergraph, where V={ν₁, . . . , ν_{N}} are the N=|V| vertices, and E={e₁ . . . e_{M}} ⊆2^{V} is the set of M=|E| hyperedges. Hence, a hyperedge e ∈ E is a set of vertices e={s₁, . . . , sₖ} such that ∀sᵢ ∈e, sᵢ ∈V. Furthermore, the hyperedges can be of any arbitrary size and are not restricted to a specific size, thus, eᵢ, eⱼ ∈E, then |eᵢ|<|eⱼ| holds.

The hyper-incidence matrix (matrix 228) of the hypergraph G where H denote the N×M hyper-incidence matrix of the hypergraph G such that Hᵢₖ=1 iff the vertex νᵢ ∈V is in the hyperedge eₖ ∈E and Hᵢₖ=0 otherwise. H ∈ [symbol] ^{N×M} connects the nodes to their hyperedges and vice-versa. Thus, Hᵢ: ∈ [symbol] ^{M} is a sparse binary vector indicating the hyperedges of node νᵢ ∈V, and conversely, H:ⱼ ∈ [symbol] ^{N} is a sparse binary vector for hyperedge eⱼ ∈E that encodes the set of nodes of eⱼ. The hyperedge degree vector d^{e} ∈ [symbol] ^{M} is d^{e}=H^{T}1_{N} where 1_{N} is the N-dimensional vector of all ones. Then the degree of a hyperedge eⱼ ∈E is simply dⱼ^{e}=ΣᵢHᵢⱼ. Alternatively, the degree of hyperedge can be obtained via hyperedge eⱼ as dⱼ^{e}=c′ⱼH′1_{N} where cⱼ is a bit mask vector consisting of all zeros but the j-th position is 1. The diagonal hyperedge node degree matrix D ∈ [symbol] ^{N×N} is defined as:

$$D = diag ( H {1}_{M} ) \qquad Equation 1$$

where D=diag (H1_{M}) is a N×N diagonal matrix with the hyperedge degree dᵢ=Σⱼ Hᵢⱼ of each vertex νᵢ ∈V on the diagonal and 1_{M}=[1 1 . . . 1]^{T} is the vector of all ones. The diagonal node degree matrix D_{ν} ∈ [symbol] ^{N×N} is defined as:

$${D}^{υ} = diag ( A {1}_{N} ) = diag ( ( {HH}^{τ} - {D}_{υ} ) {1}_{N} ) \qquad Equation 2$$

D=diag (H1_{M}) is the diagonal matrix of hyperedge node degrees where Dᵢᵢ is the number of hyperedges for node i. Conversely, D^{ν}=diag (A1_{N}) (Eq. 2) is the diagonal matrix of node degrees where Dᵢᵢ^{ν} is the degree of node i. For instance, Dᵢᵢ=2 indicates that node i is in two hyperedges, whereas Dᵢᵢ^{ν}=5 indicates that node i is actually connected to five nodes among those two hyperedges. Hence, Dᵢᵢ^{ν}=5 is the size of those two hyperedges. The diagonal hyperedge degree matrix D^{e} ∈ [symbol] ^{M×M} is defined as:

$${D}^{e} = diag ( {H}^{T} {1}_{N} ) \qquad Equation 3$$

where D^{e}=diag (Hx^{T}1_{N})=diag (d₁^{e}, d₂^{e}, . . . , d_{M}^{e}) is a M×M diagonal matrix with the hyperedge degree dⱼ^{e}=ΣᵢHᵢⱼ of each hyperedge eⱼ ∈E on the diagonal and 1_{N}=[1 1 . . . 1]^{T}. Given H, the N×N node adjacency matrix A as:

$$A = H {H}^{⊤} - D \qquad Equation 4$$

where D=is the N×N vertex degree diagonal matrix with Dᵢᵢ=Σⱼ Hᵢⱼ. Similarly, the M×M hyperedge adjacency matrix A^{(e)} is:

$${A}^{( e )} = {H}^{⊤} H - {D}^{e} \qquad Equation 5$$

where D^{e}=is the M×M hyperedge degree diagonal matrix with Dᵢᵢ^{e}=Σⱼ Hⱼᵢ. The described framework is extremely flexible and can take as input both hyperedge and/or node features, if available to generate and provide recommendations. If these initial features are not available, the system can utilize node2vec, DeepGL, Singular Value Decomposition (SVD), etc., for ϕ and ϕₑ discussed below. More formally, the initial feature function ϕ is:

$$X = ϕ ( H {H}^{⊤} - D ) ∈ {ℝ}^{N \times F} \qquad Equation 6$$

where H is the hypergraph incidence matrix, and X is the low dimensional rank-F approximation of HH^{T}-D computed via ϕ. However, if A is given as input directly, then X=ϕ(A). Similarly, if the initial hyperedge feature matrix Y is not given as input, then

$$Y = ϕ ( {H}^{⊤} H - {D}^{e} ) \qquad Equation 7$$

$$= ϕ ( {A}^{( e )} ) \qquad Equation 8$$

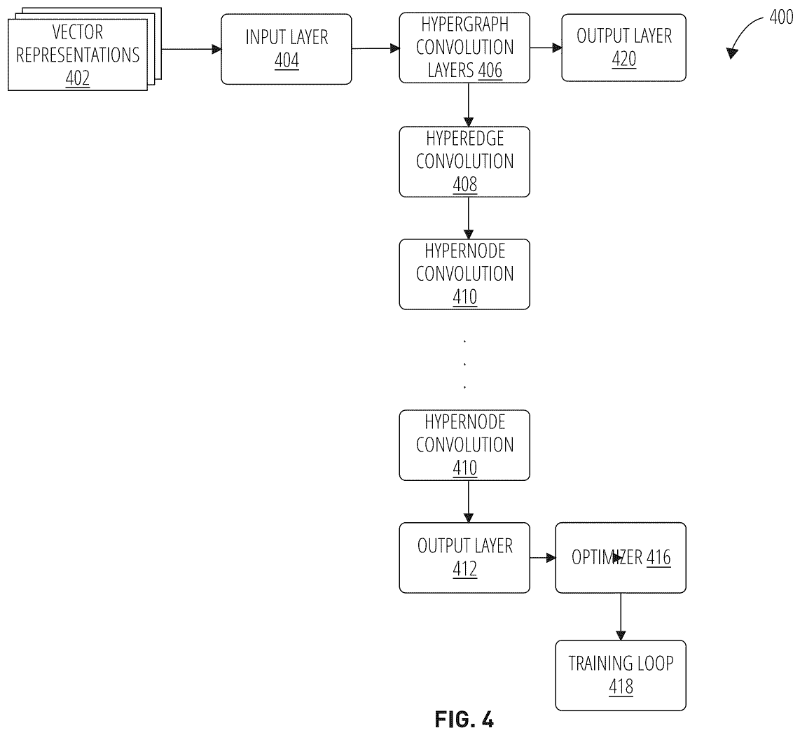

Eq. 7 is only one way to derive Y, and the framework supports other techniques to obtain Y. In one example, an initial feature matrix inference for nodes and hyperedges as a framework component is included, but does not require these as input. Below are the random walk transition matrices of the nodes and hyperedges. More formally, P∈ [symbol] ^{N×N} and Pₑ∈ [symbol] ^{M×M} as:

$$P = H {{D}_{e}^{- 1} ( {D}^{- 1} H )}^{⊤} \qquad Equation 9$$

$${P}_{e} = {( {D}^{- 1} H )}^{⊤} H {D}_{e}^{- 1} \qquad Equation 10$$

where P is the random walk node transition matrix, and Pₑ is the random walk hyperedge transition matrix. The following defines the node and hyperedge convolution below. First, Eq. 11 initializes the node embedding matrix Z(1), whereas Eq. 12 initializes the hyperedge embeddings Y(1). Note that if hyperedge features Y are given as input, then Eq. 12 is replaced with Y(1)=Y. Afterwards, Eq. 13-14 defines the hypergraph convolutional layers of our model (see FIG. 4), including the node hypergraph convolutional layer in Eq. 13 (block(s) 410) and the hyperedge convolutional layer in Eq. 14 (block(s) 408). More formally,

$${Z}^{( 1 )} = X or {Z}^{( 1 )} = ϕ ( H {H}^{⊤} - D ) \qquad Equation 11$$

$${Y}^{( 1 )} = {( {D}^{- 1} H )}^{⊤} {Z}^{( 1 )} or {Y}^{( 1 )} = ϕ ( {H}^{⊤} H - {D}^{e} ) \qquad Equation 12$$

$${Z}^{( k + 1 )} = σ ( ( {D}^{- 1} {HP}_{e} {D}_{e}^{- 1} {H}^{⊤} {D}^{- 1} {Z}^{( k )} + {D}^{- 1} {HY}^{( k )} ) {W}^{( k )} ) \qquad Equation 13$$

$${Y}^{( k + 1 )} = σ ( ( {D}_{e}^{- 1} {H}^{⊤} P {D}^{- 1} H {D}_{e}^{- 1} {Y}^{( k )} + {( {HD}_{e}^{- 1} )}^{⊤} {Z}^{( k + 1 )} ) {W}_{e}^{( k )} ) \qquad Equation 14$$

where Z^{(k)} are the updated node embeddings of the hypergraph at layer k whereas Y^{(k+1)} is the updated hyperedge embeddings at layer k. Furthermore, W^{(k)} and Wₑ^{(k)} are the learned weight matrices of the kth layer for nodes and hyperedges, respectively. The node embeddings at each layer are updated using the hyperedge embedding matrix D⁻¹HY^{(k)}, and similarly, the hyperedge embeddings at each layer are also updated using the (HDₑ⁻¹)^{T} Z^{(k+1)} node embedding matrix. The process repeats until convergence.

FIG. 4 illustrates an example of a high-level training processing flow 400 to train or learn one or more models utilizing a hypergraph, as described above. In one example, the operations discussed with respect to FIG. 4 are performed by the training module 110. The systems discussed herein go through a number of processes to ensure that in-use predictions or recommendations are valid, e.g., helpful suggestions during a design period. As previously discussed, the hypergraph is initially constructed. This involves creating a set of nodes and edges to represent the data. As discussed, the nodes represent the entities in the data, such as style elements. The edges represent the relationships between the entities, such as the co-occurrences of style elements within a spatial region, e.g., within a division or section of an HTML document. Next, the hypergraph is embedded, which involves converting the nodes and edges into a vector representation, as previously discussed. The vector representation of a node captures the features of the entity it represents. The vector representation of an edge captures the features of the relationship it represents. The hypergraph neural network is then trained. Specifically, training involves learning a set of weights that can be used to predict the labels of the nodes. The training process uses the vector representations 402 generated from an HTML document corpus.

In embodiments, the input layer 404 receives the initial hypergraph representation and its associated features, e.g., the vector representations 402. In some instances, the input layer 404 initializes the node embeddings, eg., see Eq. 11 and description, and the hyperedge embeddings, see Eq. 12 and description.

In embodiments, the processing flow 400 includes one or more hyperedge convolution layer(s) 408 and one or more hypernode convolution layer(s) 410. The Hypergraph Convolution (Hyperedge Conv) Layers 408 (see eq. 14 of FIG. 3) and Hypernode Convolution Layers 410 (see eq. 13 of FIG. 3) process the hypergraph, convolving and aggregating information to capture relationships between hyperedges and hypernodes, as discussed herein.

In embodiments, a hyperedge convolution layer 408 learns to weight the relationships between the entities in the data allowing the hyperedge convolution layer to learn to represent the data and provide design suggestions. A hyperedge convolution layer 408 can be implemented in a variety of ways, including as discussed herein. In some instances, a shared weight matrix for each hyperedge is utilized. The weight matrix is multiplied by the features of the vertices that are connected by the hyperedge. The result is a new feature vector for each vertex.

Similarly, a hypernode convolution layer(s) 410 can also be is implemented using a shared weight matrix for each hypernode. The weight matrix is multiplied by the features of the vertices and hypernodes that are connected by the hypernode. The result is a new feature vector for each vertex and hypernode.

In embodiments, the number of convolution layers depends on the complexity of the problem and the size of the hypergraph. The optimal number of layers is a tradeoff between performance and resources. However, too few layers may not be able to learn the patterns in the data. Thus, the number of layers utilized must be enough to learn patterns.

In embodiments, the final convolution layer outputs a new feature vector for each vertex in the hypergraph, which is processed by the output layer 412. The new feature vector is a weighted sum of the features of the vertices that are connected to the vertex by the hyperedge. The weights are learned during the training process. As discussed, the output of the hypergraph is useful because it represents relationships between design elements that are used to provide suggestions. The output layer 412 receives the final representation from the previous layers and performs the final computation or prediction. The output layer 412 is connected to the previous layer in the network via a weight matrix. The weights in the weight matrix are learned during the training process, and they determine how the output of the previous layer is combined to produce the output of the output layer 412.

In embodiments, the output of the output layer 412 is sent to and processed by a loss function 414. The loss function 414 measures the error between the output of the network and the ground truth labels. In one example, the loss function 414 is a cross-entropy loss function that is calculated as the negative log-likelihood of the ground truth labels. In other instances, the loss function 414 is a mean squared error function calculates the average squared error between the predicted output and the ground truth label or a hinge loss function. The system determines a hinge loss as the maximum of 0 and 1 minus the dot product of the predicted output and the ground truth labels.

In embodiments, an optimizer 416 receives the output of the loss function 414 and performs further processing, including updating the weights. In one example, the optimizer 416 uses a gradient descent algorithm to update the weights, which iteratively adjusts the weights in order to reduce the loss function.

The processing flow 400 further includes a training loop 418 that iterates over the training data, passing it through the network, calculating the loss, and updating the model parameters. The training loop 418 continues until a convergence criterion is met.

The following is an example of a training objective performed on HTML data. Let E={e₁, e₂, . . . } denote a set of known hyperedges in the hypergraph G where every hyperedge eₜ={s₁, . . . , sₖ}∈E represents a set of nodes that can be of any arbitrary size k=|eₜ|. This is important since HTML fragments that represent hyperedges in the heterogeneous hypergraph can be varying sizes, e.g., simple HTML fragments only have a few entities whereas more complex HTML fragment designs consist of many entities. Hence, for any two hyperedges eₜ, e′ₜ∈E, then |eₜ|≠|e′ₜ| may hold. Further, let F be a set of sampled vertex sets from the set 2^{v}-E of unknown hyperedges. Given an arbitrary hyperedge e ∈E ∪F, a hyperedge score function ƒ is:

$$f : e = \{ {x}_{1} , … , {x}_{k} \} \to w \qquad Equation 15$$

Hence, ƒ is a hyperedge score function that maps the set of d-dimensional node embedding vectors {x₁, . . . , xₖ} of the hyperedge e to a score ƒ (e={x₁, . . . , xₖ}) or simply ƒ(e). Notably, this approach is flexible for use with a wide range of hyperedge score functions. Equations 17 and 18 illustrate a few examples. Then, the hyperedge prediction loss function is:

$$ℒ = - \frac{1}{E ⋃ F} {\sum }_{e ∈ E ⋃ F} {Y}_{e} log - ( ρ ( f ( {e}_{t} ) ) ) + ( 1 - {Y}_{e} ) log ( 1 - ρ ( f ( {e}_{t} ) ) ) \qquad Equation 16$$

where Yₑ=1 if e ∈ E and otherwise Yₑ=0 if e ∈ F. Further, let

$$ρ ( f ( {e}_{t} ) ) = \frac{1}{1 + exp [ - 1 f ( {e}_{t} ) ]}$$

where p(eₜ)=ρ(ƒ(eₜ)) is the probability of hyperedge eₜ existing in the hypergraph G. The following are examples of hyperedge score functions ƒ for deriving scores for such HTML fragments. The hyperedge score ƒ (e) can be derived as the mean cosine similarity between any pair of nodes in the hyperedge e ∈ E as follows:

$$f ( e ) = \frac{1}{T} {\sum }_{i , j ∈ e s . t . 1 > j} {x}_{i}^{T} {x}_{j} \qquad Equation 17$$

where

$$T = \frac{\vert e \vert ( e \vert - 1 )}{2}$$

is the number of unique node pairs i, j in the hyperedge e. The hyperedge score ƒ (e) is largest when all nodes in the set e={s₁, s₂, . . . } have similar embeddings. In the extreme, ƒ (e)→1 implies ϰᵢ^{T}ϰⱼ=1 for all i, j ∈e. Conversely, when ƒ (e)→0, then ϰᵢ^{T}ϰⱼ=0 for all i, j ∈e, implying that the set of nodes in the hyperedge are independent with orthogonal embedding vectors. When 0<ƒ (e)<1 lies between these two extremes, this indicates intermediate similarity or dissimilarity. Furthermore, the approach extends to the inductive learning setting where a given a new unseen HTML fragment representing a set of entities, that is, a new unseen hyperedge, as will be discussed in more detail below.

For example, a new unseen fragment can leverage the hyperedge score function to obtain a score for this new unseen fragment, which indicates how well these entities go together to form a well-designed HTML fragment, e.g., to provide suggestions. If the embeddings from each entity in the fragment are similar, then the function ƒ will score this fragment higher than a fragment with dissimilar entities where the notion of similarity is learned from the large corpus of professionally designed HTML emails/documents. Alternatively, a hyperedge score function ƒ c based on the difference between the max and min value over the set of nodes in the hyperedge e also can be used to identify suggestions. More formally, suppose we have a hyperedge e with k nodes, x₁, . . . , xₖ ∈ R^{d}, then

$$f ( e ) = {max}_{i ∈ \vert k \vert} {x}_{i} - {min}_{j ∈ \vert k \vert} {x}_{j} \qquad Equation 18$$

where ƒ (e) is the difference between its maximum and minimum value over all nodes in the hyperedge e.

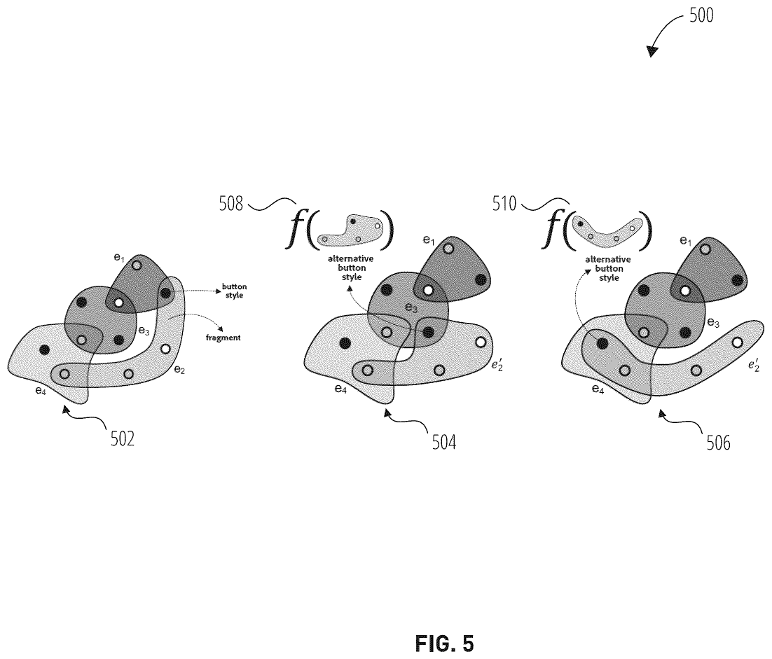

FIG. 5 illustrates an example of fragment designs 500 in accordance with embodiments. FIG. 5 is a simple example illustrating leveraging the hyperedge scoring functions to obtain scores for HTML fragments with different button styles. In this example, the fragment design A 502 is the original design. Fragment design B 504 and fragment design C 506 illustrate two alternative HTML fragments that differ by only a single node. That is, instead of the button style in 502, it is replaced with an alternative button style 508 or alternative button style 510. Hence, even for this simple case, the above-described approach is utilized to score such fragments and recommend the top-k of those to aid in the design process. This result generalizes to any such fragment consisting of a set of style and design elements. The above-described score functions (eq. 17 or eq. 18) can be used to score fragments that a designer has already created, which is useful for improving the design.

In embodiments, the systems and methods discussed herein provide recommendations or suggestions for existing HTML documents or new HTML documents during the creation stage. FIG. 5 illustrates an example of providing alternative button style suggestions for a pre-existing HTML document. In some embodiments, the modeling and suggestions techniques discussed herein are implemented in and/or operate with an HTML design tool.

FIG. 6 illustrates an example of a simplified HTML builder 600 in accordance with the embodiments discussed. Note that FIG. 6 only illustrates a simplified version of an HTML builder 600 for discussion purposes and the HTML builder 600 in implementation is typically much more complex with many different options.

The HTML builder 600 is a tool utilized to create and design HTML documents that are both visually appealing and effective. In embodiments, HTML builder 600 features a drag-and-drop interface 604 that makes it easy to add and arrange content, as well as a wide range of other tools and features that allows a user to customize the look and feel a document. Additional features may include a what-you-see-is-what-you-get (WYSIWYG) editor present a previews of what the document looks like as it is being created. Other tools include styled templates, customization tools, and testing tools. The style templates include a wide range of style templates that a user can use to create a portion or fragments of a document.

In embodiments, the HTML builder 600 includes a variety of customization tools that allow a user to change the look and feel of a document. For example, the customization tools enable users to change the fonts, colors, and layout of a document. One feature of customization tools includes providing suggestions or recommendations for one or more style elements and/or fragments of a document based on applying a trained model to a document in design, as discussed herein. The HTML builder 600 also includes a variety of testing tools that enable a user to preview documents in different display clients, e.g., different web browsers, email clients, text editors, etc.

The HTML builder 600 illustrated in FIG. 6 is divided into a number of sections or fragments, i.e., fragment 602a-fragment 602d. Each fragment can be edited via the HTML builder 600 to generate an entire document for a user. In one example, each of the fragments 602 includes a browse button 606 enabling a user to browse through templates for the fragments, pick elements, pick styles for elements, etc. In embodiments, the HTML builder 600 provides suggestions during the development of a document. For example, the HTML builder 600 recommends one or more styles for one or more elements or an entire fragment, i.e., recommend an entire style for a fragment. In another example, the HTML builder 600 recommends a style for a particular element, e.g., a button, a background, a font, etc. In some instances, selecting the browse button 606 provides the user with recommendations or suggestions. However, the suggestions can also be provided through other means. During the development of a document, the HTML builder 600 deploys and utilizes the generator system 102 and its components to provide real-time suggestions or recommendations for the fragments and/or style elements.

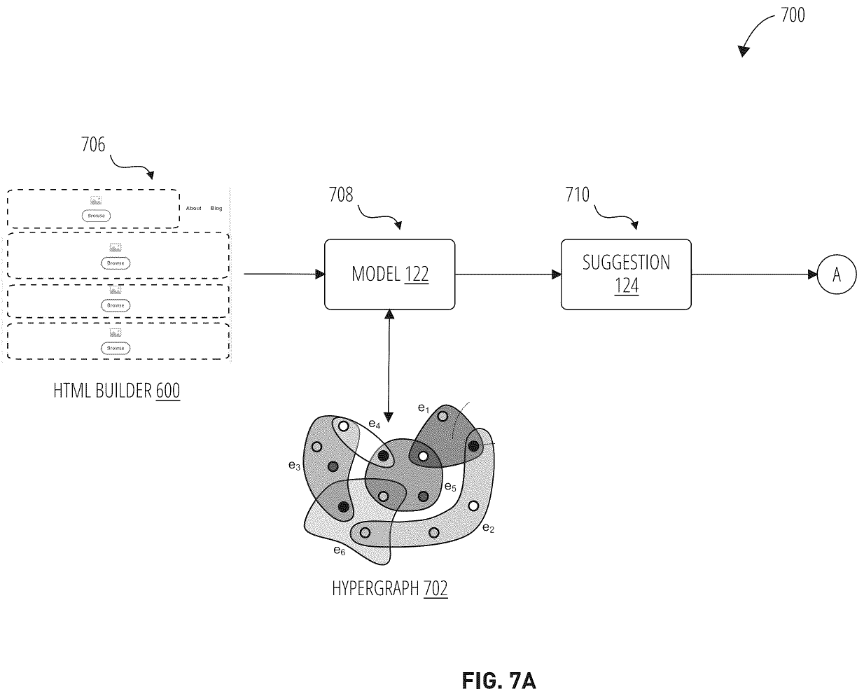

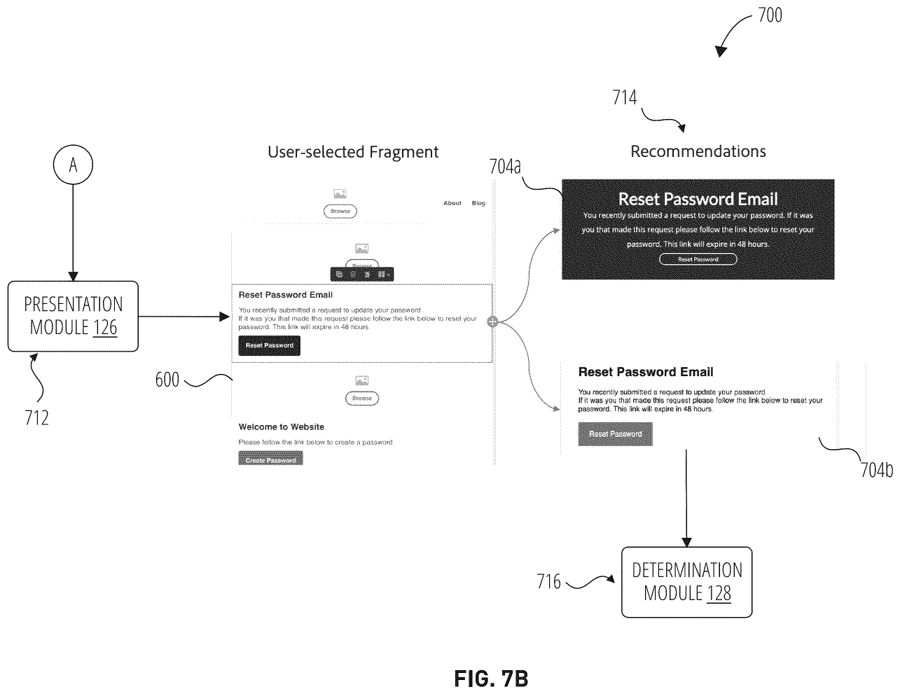

FIGS. 7A and 7B illustrate an example processing flow 700 of processing to provide suggestions during the creation or editing of an HTML document. In embodiments, a user utilizes an HTML builder 600 to create an HTML document. In the illustrated example, the HTML builder 600 enables a user to build the document in sections or fragments 602.

At 706, the HTML builder 600 is utilized to build an HTML document, including one or more fragments. As previously mentioned, each fragment is configurable with style elements of one or more different types. In some instances, the HTML builder 600 presents the user with one or more suggestions for style elements or fragments.

In one example, the HTML builder 600 sends requests for one or more suggestions for style elements and/or fragments to the generator system 120, including the model module 122. The model module 122 provides or enables the style suggestion module 124 to utilize a trained hypergraph model 702 to score a particular fragment with one or more alternative or candidate style elements, e.g., different button styles, using the learned embeddings. The alternative or candidate style elements are selected by the style suggestion module 124 to score with a candidate fragment. In one example, the style suggestion module 124 generates a score for the candidate fragment with every candidate style element of the particular type (button style). In other instances, the style suggestion module 124 selects a subset of all style elements to utilize as candidate style elements. The selection is based a user selection, a preference setting, other style elements in the candidate fragment, etc. In some embodiments, the style suggestion module 124 generates a score using a scoring function, such as the mean cosine similarity approach, as previously discussed above with equation 17, or the max and min value approach discussed above with equation 18.

The style suggestion module 124 scores each fragment with the different style element options and generates a list of scores at 710. In some instances, the style suggestion module 124 sorts the scores and recommends to the user the top-k style elements, where k is the desired number of recommendations with the largest scores (weight). The style suggestion module 124 provides the list of recommendations to the presentation module 126 at 712. As discussed, the style suggestion module 124 can score the same candidate fragment with different candidate style elements to determine a rank list of candidate style elements.

In embodiments, the presentation module 126 presents each of the one or more recommendations to the user. In one example, the presentation module 126 generates a fragment with each alternative recommendation and presents the alternative fragments to the user, as illustrated at 714. Specifically, at 714, the presentation module 126 presents a first style suggestion 704a and a second style suggestion 704b for the user to choose between. Note, in the illustrated example, each recommendation includes a number of different style element changes between the recommendations. The first style suggestion 704a has a black background, white text, different font, a first style of a button, etc., while the style suggestion 704b has a white background, black text, different font/text, and a second style of a button. As previously mentioned, the recommendations can be for one or more style elements or for completely different fragments themselves.

At 716, the determination module 128 processes a selection of at least one of the recommendations presented to a user. Specifically, the determination module 128 applies the selected recommendation to the HTML document.

This process may be repeated any number of times while an HTML document is being generated. In some instances, the generator system 120 automatically generates fragments and/or select style elements for HTML documents. In one example, the generator system 120, including the style suggestion module 124 automatically selects and uses the highest score element or fragment.

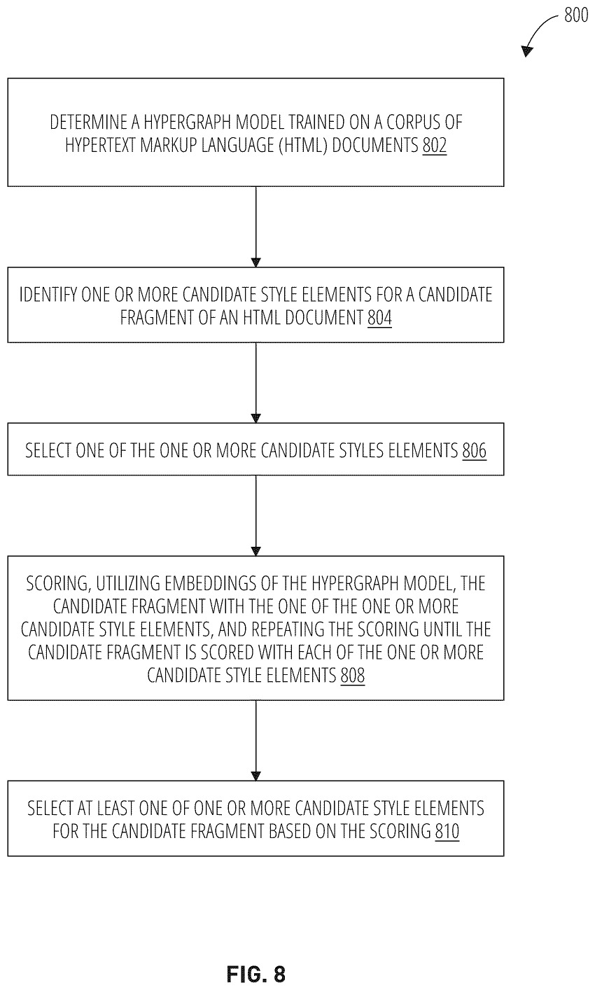

FIG. 8 illustrates an example of a routine 800 in accordance with embodiments. Specifically, the routine 800 is performed by the systems discussed herein, e.g., generator system 120 and components, to identify suggestions or recommendations for style elements and/or fragments.

In block 802, the routine 800 includes determining a hypergraph model trained on a corpus of hypertext markup language (HTML) documents. In one example, the hypergraph model is selected on the corpus used to train the model and the HTML document being designed, e.g., the HTML document being developed is the type of document of the corpus. In embodiments, the hypergraph model includes nodes and hyperedges. In one example, each of the nodes corresponds to a style element of a plurality of style elements, and each hyperedge corresponds to one of a plurality of fragments in the HTML documents of the corpus. Nodes can also be included to capture spatial relationships between neighboring fragments.

In block 804, the routine 800 includes identifying one or more candidate style elements for a candidate fragment of an HTML document. In one example, the one or more candidate style elements is each style element option for a given type of style element. For example, every color available for the style element text color, every button style available for a button style element, etc. In some instances, the one or more candidate style element is a subset of the all the options available.

In block 806, the routine 800 includes selecting one of the one or more candidate styles elements. And at block 808, the routine 800 includes scoring, by utilizing embeddings of the hypergraph model, the candidate fragment with the selected one of the one or more candidate style elements. Further, the process is repeated until all candidate style elements are scored with the candidate fragment.

In block 810, the routine 800 includes selecting at least one of one or more candidate style elements for the candidate fragment based on the scoring. In one example, the top k candidate style elements with the highest scores are selected. In embodiments, the generator system 120 presents the selected candidate style elements to a user, receives a selection of one of the candidates, and updates a fragment with the user selected style element.

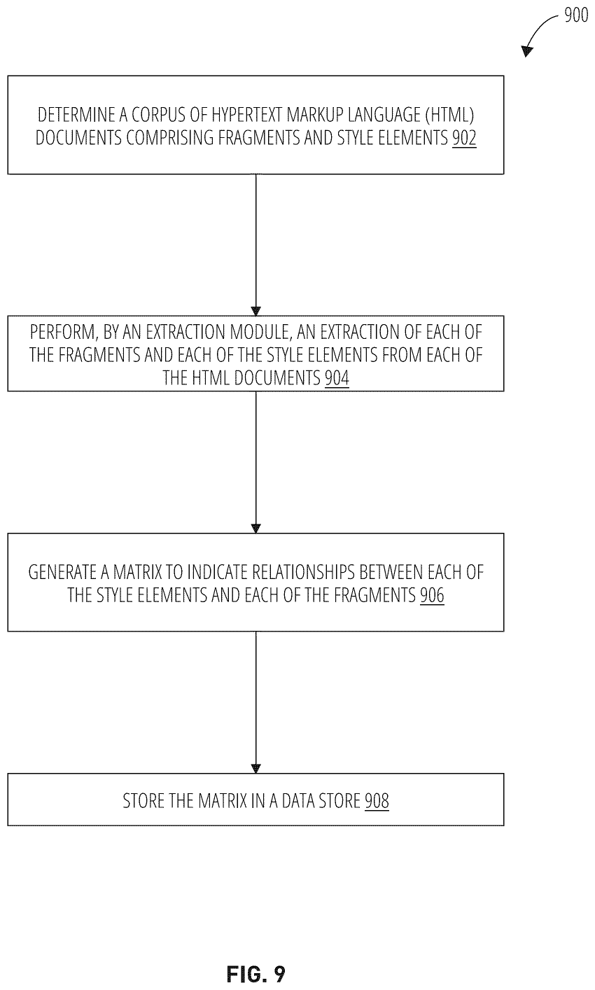

FIG. 9 illustrates an example routine 900 in accordance with embodiments discussed herein. Specifically, the routine 900 is one example of processing a corpus to identify relationships in HTML documents.

In block 902, the routine 900 includes determining a corpus of hypertext markup language (HTML) documents comprising fragments and style elements. The corpus typically includes a high number of HTML document examples, e.g., greater than a thousand, to properly train a model. In embodiments, the HTML documents typically include various design or style elements. The style elements are organized in different sections or fragments of a document. Thus, each style element within a particular fragment will have a design relationship with other elements in the same fragment that is identified during a training process, as discussed herein. The design style element generally include text and graphical elements.

In block 904, the routine 900 includes performing an extraction of each of the fragments and each of the style elements from each of the HTML documents. In one example, the fragments are identified via HTML tags or identifiers, e.g., the <div> tag. The style elements within a particular fragment is included within the area defined by the <div> tag. Other detection techniques are also utilized. In another example, each fragment is identified via edge detection techniques and the associated style elements are identified within the boundaries of the edge detection.

In block 906, the routine 900 includes generating a matrix and vector representations to indicate relationships between each of the style elements and each of the fragments. For example, at least one relationship exists if a particular fragment includes a particular style element. The matrix includes rows that represent each fragment and columns that represent each style element. The matrix includes a 1 or some other indicator in a cell if a fragment includes a style element and a 0 or a different indicator if the fragment does not include the style element. The system processes the entire corpus of HTML documents and identifies the relationships between the fragments and the style elements. The system also identifies spatial relationships among the fragment as previously discussed in FIG. 2B. Thus, each fragment can also be represented in a column and have an indication in rows of neighboring fragments within a document. In embodiments, the matrix can be a multidimensional matrix, as previously discussed, and embodiments are not limited in this manner.

In block 908, routine 900 stores the matrix in a data store. Typically, the matrix is stored as vector representations in any type of data store, e.g., storage device, cloud storage, etc. The matrix is then utilized to train models to identify and/or provide recommendations for future design documents.

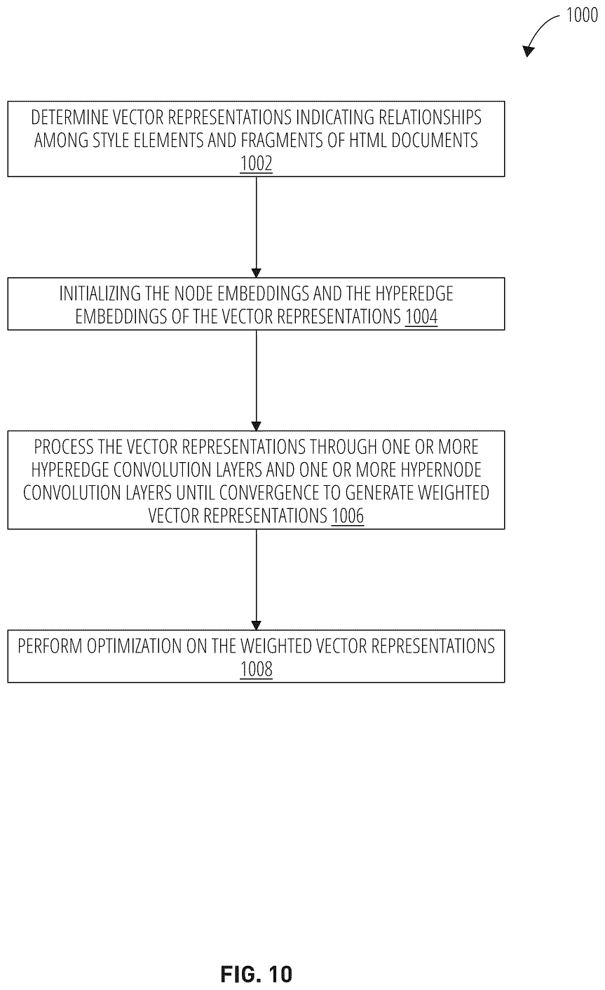

FIG. 10 illustrates an example of a routine 1000 in accordance with embodiments. Specifically, routine 1000 is directed operations performed by systems and components discussed herein to train a model, e.g., a hypergraph neural network model.

In block 1002, routine 1000 determines vector representations indicating relationships among style elements and fragments of HTML documents. As previously discussed, the vector representations are identified as part of an extraction process performed on HTML documents and represent relationships in the data. In one example, a vector representation identifies style elements within fragments and fragments with neighboring fragments. These identifications provide a high likelihood of design coherence.

In block 1004, the routine 1000 includes initializing the node embeddings and the hyperedge embeddings of the vector representations. For example, an input layer is configured to assign the initial values to the vectors that represent each node in the graph and initial values to the vectors that represent each hyperedge in the graph. In one example, pre-trained embeddings based on the extraction are utilized.

In block 1006, the routine 1000 includes processing the vector representations through one or more hyperedge convolution layers and one or more hypernode convolution layers until convergence to generate weighted vector representations. The convolution layers may process the data by applying a filter or weights that are learned during the training and generating new weighted vector representations. The number of filters applied is based on the size of the filter and the stride (number of nodes/edges) the filter moves over.

In block 1008, routine 1000 performs optimization on the weighted vector representations. For example, an optimizer 416 performs further processing including updating the weights. The optimizer 416 uses a gradient descent algorithm to update the weights, which iteratively adjusts the weights in order to reduce the loss function.

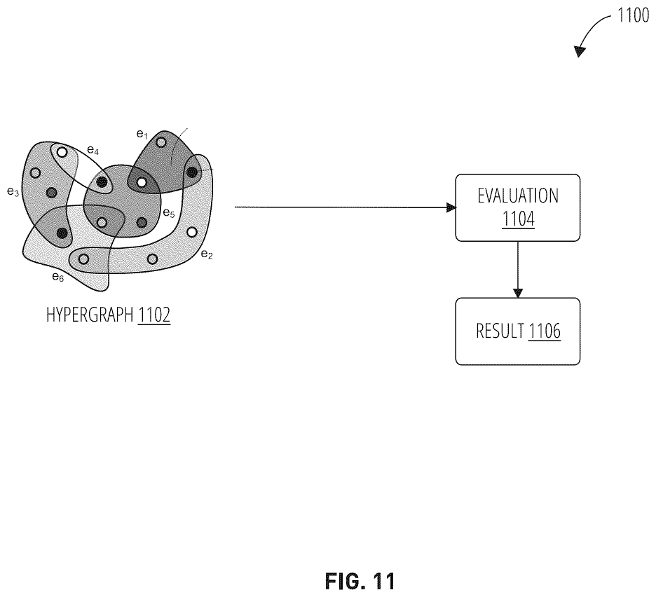

FIG. 11 illustrates an example of an evaluation process 1100 in accordance with embodiments discussed herein. In embodiments, the evaluation process 1100 is applied to a hypergraph 1102 generated based on the approach previously discussed to determine the effectiveness of the model and generate a result 1106. In one example, to quantitatively evaluate the effectiveness of the model, a fraction p of links in the hypergraph that occur between a fragment and a specific style entity (e.g., button-style) are held out to use as ground-truth for quantitative evaluation of the model for the style recommendation tasks. For example, assume the model and approach are leveraged for recommending button-styles, a fraction of the p links that occur between a fragment and a button-style are uniformly randomly selected and the remaining 1-p links between fragments and button-styles are used for training (along with all the other links in the hypergraph between different types of entities such as background-styles). The evaluation module 1104 trains using the training graph (which doesn't contain the p % of held-out links between a fragment and button-style). The evaluation module 1104 processes a set of VB unique button-styles where VB is all possible unique button-style nodes in the hypergraph. Given a held-out link (ƒi, bj) between a fragment ƒi and button-style bj, the evaluation module 1104 derive a score between the fragment ƒi and every button-style bk ∈ VB using the learned embeddings by:

$${w}_{i} = f ( {z}_{i} , {z}_{j} ) , ∀ k ∈ {V}_{B} \qquad Equation 19$$

where wᵢ=[wᵢ₂, wᵢ₂, . . . w_{i|V}_{_{B}}_{|}] is of length |V_{B}| and each entry corresponds to a score between fragment ƒᵢ and a button style bₖ ∈ V_{B}. Given the vector wᵢ of scores for fragment ƒᵢ, the evaluation module 1104 sorts the scores and recommends the top-K button-styles with the largest weight. To quantitatively evaluate the performance of the approach for this ranking task, the evaluation module 1104 utilizes HR@K and nDCG@K where K={1, 5, 10, 25, 50}. The evaluation module 1104 repeats the above for each of the held-out links in the test set (e.g., between a fragment and buttonstyle) and reports the average of the evaluation metrics. For instance, the mean HR@K and nDCG@K where K={1, 5, 10, 25, 50} over all held-out test edges.

In some instances, the evaluation module 1104 compares the approach discussed herein to several common-sense baseline methods including random that recommends a style or design element uniformly at random among the set of possibilities, popularity (pop) that recommends the most frequent style, and HyperGCN. The results showing the effectiveness of the various approaches for recommending the top button-styles are provided in Table 3 as one example.

TABLE 3
Results for Button Style Recommendation.

| | HR@K | | | | nDCG@K | | | |
|---|---|---|---|---|---|---|---|---|
| Model | @1 | @10 | @25 | @50 | @1 | @10 | @25 | @50 |
| Random | 0.000 ± 0.00 | 0.000 ± 0.00 | 0.018 ± 0.00 | 0.027 ± 0.00 | 0.000 ± 0.00 | 0.000 ± 0.00 | 0.004 ± 0.00 | 0.006 ± 0.00 |
| Pop. | 0.000 ± 0.00 | 0.000 ± 0.00 | 0.009 ± 0.00 | 0.009 ± 0.00 | 0.000 ± 0.00 | 0.002 ± 0.00 | 0.003 ± 0.00 | 0.005 ± 0.00 |
| HyperCCN | 0.008 ± 0.01 | 0.011 ± 0.00 | 0.043 ± 0.02 | 0.066 ± 0.03 | 0.008 ± 0.01 | 0.009 ± 0.00 | 0.017 ± 0.01 | 0.021 ± 0.01 |
| HNN | 0.243 ± 0.05 | 0.477 ± 0.03 | 0.536 ± 0.06 | 0.594 ± 0.05 | 0.243 ± 0.05 | 0.354 ± 0.04 | 0.368 ± 0.04 | 0.379 ± 0.04 |

Notably, the approach discussed herein performs significantly better than the other models across both HR@K and nDCG@K for all K E {1, 10, 25, 50}. In many instances, the simple random and popularity baseline are completely ineffective with HR@K and nDCG@K of 0 when K is small (top-1 or 10). In contrast, the approach discussed herein is able to recover the ground-truth button-style 24% of the time in the top-1 as shown in Table 3.

Further, results for recommending useful background-styles are reported in Table 4 as one example.

TABLE 4
Results for Background Style Recommendation.

| | HR@K | | | | nDCG@K | | | |
|---|---|---|---|---|---|---|---|---|
| Model | @1 | @10 | @25 | @50 | @1 | @10 | @25 | @50 |
| Random | 0.000 ± 0.00 | 0.000 ± 0.00 | 0.000 ± 0.00 | 0.074 ± 0.00 | 0.000 ± 0.00 | 0.000 ± 0.00 | 0.000 ± 0.00 | 0.013 ± 0.00 |
| Pop. | 0.000 ± 0.00 | 0.000 ± 0.00 | 0.000 ± 0.00 | 0.000 ± 0.00 | 0.001 ± 0.00 | 0.006 ± 0.00 | 0.010 ± 0.00 | 0.016 ± 0.00 |
| HyperCCN | 0.000 ± 0.00 | 0.031 ± 0.04 | 0.061 ± 0.06 | 0.147 ± 0.14 | 0.000 ± 0.00 | 0.018 ± 0.02 | 0.025 ± 0.03 | 0.041 ± 0.04 |
| HNN | 0.151 ± 0.11 | 0.457 ± 0.14 | 0.552 ± 0.10 | 0.741 ± 0.08 | 0.181 ± 0.11 | 0.308 ± 0.11 | 0.333 ± 0.11 | 0.369 ± 0.10 |

The approach discussed herein performs best, achieving a significantly better HR and nDCG across all K, as shown in Table 4. It is important to note that results at smaller K are more important, and these are precisely the situations where the other models completely fail, that is, for top-1 all approaches have a HR of 0 indicating they are never able to correctly recover the ground-truth background-style that was held-out.

In some instances, the evaluation module 1104 generates and outputs a result 1106. The result 1106, in some instances, are the scores generated based on the above analysis. In some embodiments, the scores are provided back to the training system 102 as feedback and the training system 102 utilizes the result 1106 to make adjustments to the model, e.g., update the weights, modify the hypergraph and the vector representations, etc.

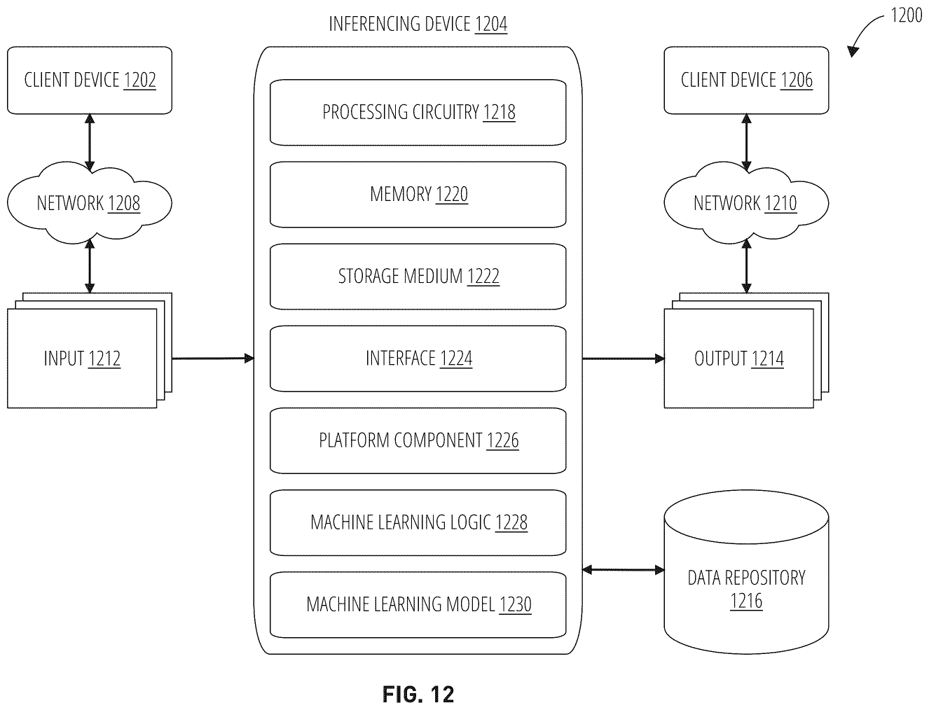

FIG. 12 illustrates an embodiment of a system 1200. The system 1200 is suitable for implementing one or more embodiments as described herein. In one embodiment, for example, the system 1200 is an AI/ML system suitable for processing HTML documents include graphical and textual designs to identify relationships in the design elements.

The system 1200 comprises a set of M devices, where M is any positive integer. FIG. 12 depicts three devices (M=3), including a client device 1202, an inferencing device 1204, and a client device 1206. The inferencing device 1204 communicates information with the client device 1202 and the client device 1206 over a network 1208 and a network 1210, respectively. The information includes input 1212 from the client device 1202 and output 1214 to the client device 1206, or vice-versa. In one alternative, the input 1212 and the output 1214 are communicated between the same client device 1202 or client device 1206. In another alternative, the input 1212 and the output 1214 are stored in a data repository 1216. In yet another alternative, the input 1212 and the output 1214 are communicated via a platform component 1226 of the inferencing device 1204, such as an input/output (I/O) device (e.g., a touchscreen, a microphone, a speaker, etc.).

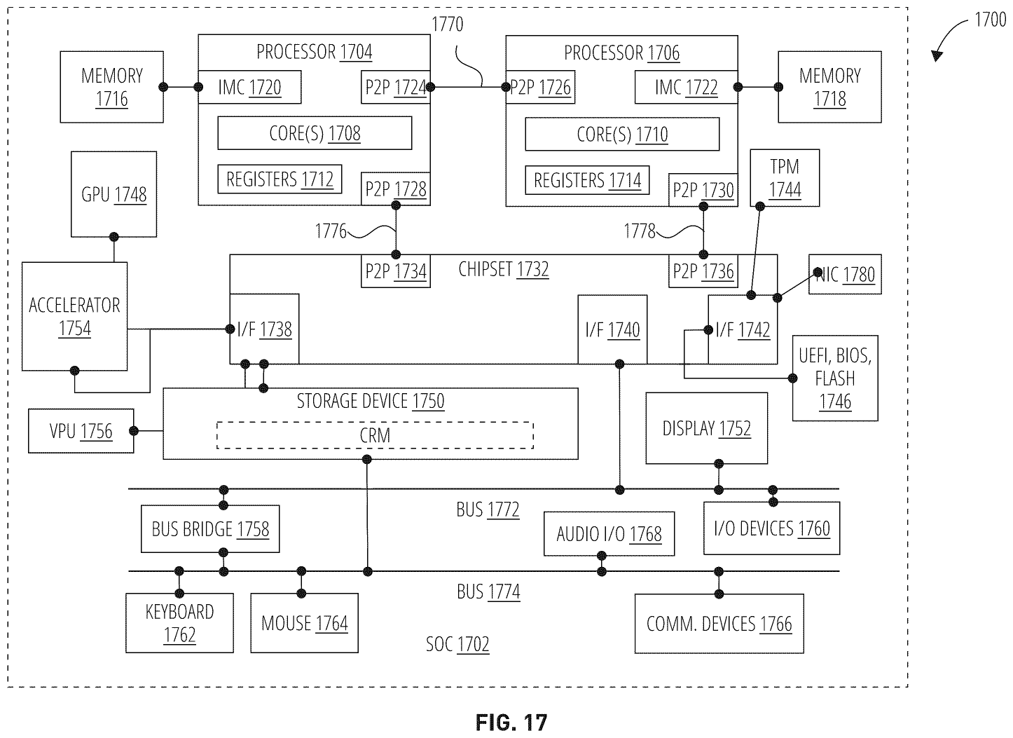

As depicted in FIG. 12, the inferencing device 1204 includes processing circuitry 1218, a memory 1220, a storage medium 1222, an interface 1224, a platform component 1226, ML logic 1228, and an ML model 1230. In some implementations, the inferencing device 1204 includes other components or devices as well. Examples for software elements and hardware elements of the inferencing device 1204 are described in more detail with reference to a computing architecture 1700 as depicted in FIG. 17. Embodiments are not limited to these examples.

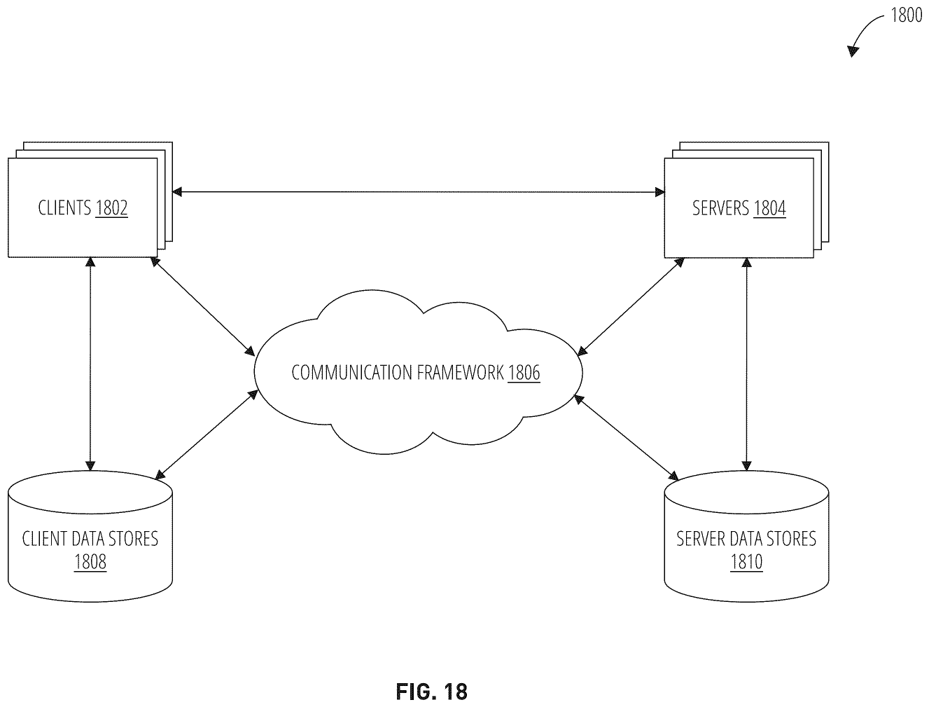

The inferencing device 1204 is generally arranged to receive an input 1212, process the input 1212 via one or more AI/ML techniques, and send an output 1214. In one example, the input 1212 is a model and an HTML document being generated. The inferencing device 1204 receives the input 1212 from the client device 1202 via the network 1208, the client device 1206 via the network 1210, the platform component 1226 (e.g., a touchscreen as a text command or microphone as a voice command), the memory 1220, the storage medium 1222 or the data repository 1216. The inferencing device 1204 sends the output 1214 to the client device 1202 via the network 1208, the client device 1206 via the network 1210, the platform component 1226 (e.g., a touchscreen to present text, graphic or video information or speaker to reproduce audio information), the memory 1220, the storage medium 1222 or the data repository 1216. The output 1214 includes one or more recommendation style elements. Examples for the software elements and hardware elements of the network 1208 and the network 1210 are described in more detail with reference to a communications architecture 1800 as depicted in FIG. 18. Embodiments are not limited to these examples.

The inferencing device 1204 includes ML logic 1228 and an ML model 1230 to implement various AI/ML techniques for various AI/ML tasks. The ML logic 1228 receives the input 1212, and processes the input 1212 using the ML model 1230, e.g., identifies style element candidates that can be implemented in a design. The ML model 1230 performs inferencing operations to generate an inference for a specific task from the input 1212. In some cases, the inference is part of the output 1214. The output 1214 is used by the client device 1202, the inferencing device 1204, or the client device 1206 to perform subsequent actions in response to the output 1214.

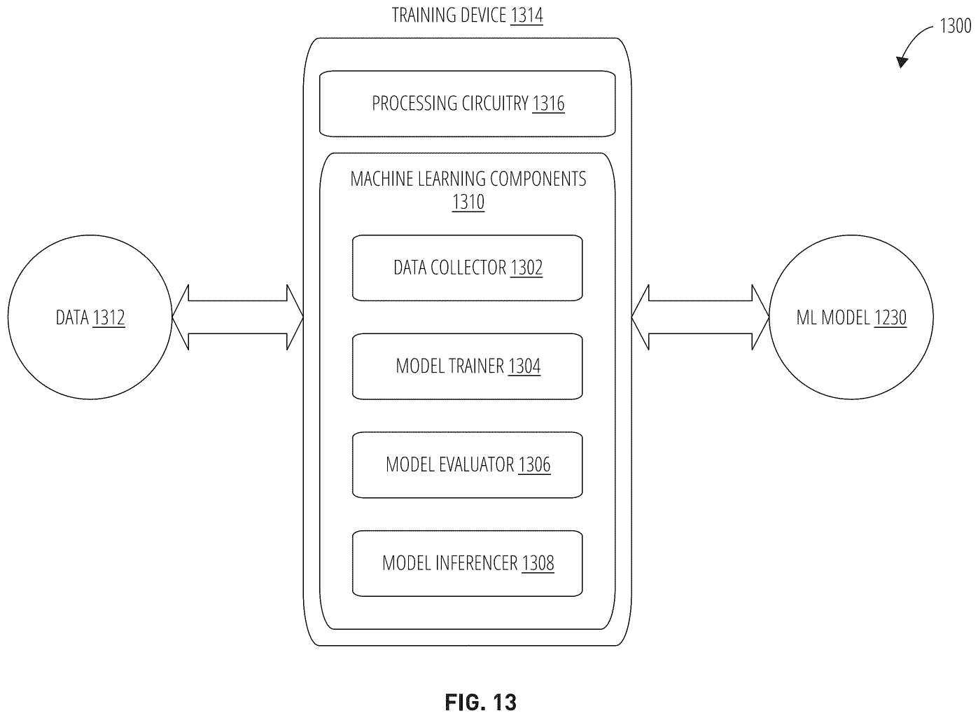

In various embodiments, the ML model 1230 is a trained ML model 1230 using a set of training operations. An example of training operations to train the ML model 1230 is described with reference to FIG. 13.

FIG. 13 illustrates an apparatus 1300. The apparatus 1300 depicts a training device 1314 suitable to generate a trained ML model 1230 for the inferencing device 1204 of the system 1200. As depicted in FIG. 13, the training device 1314 includes a processing circuitry 1316 and a set of ML components 1310 to support various AI/ML techniques, such as a data collector 1302, a model trainer 1304, a model evaluator 1306 and a model inferencer 1308. In one example, the training device 1314 performs the training operations, as discussed in FIG. 1 and/or FIG. 4.

In general, the data collector 1302 collects data 1312 from one or more data sources to use as training data for the ML model 1230, e.g., generate a corpus of HTML documents. The data collector 1302 collects different types of data 1312, such as text information, audio information, image information, video information, graphic information, and so forth. The model trainer 1304 receives as input the collected data and uses a portion of the collected data as test data for an AI/ML algorithm to train the ML model 1230. The model evaluator 1306 evaluates and improves the trained ML model 1230 using a portion of the collected data as test data to test the ML model 1230. The model evaluator 1306 also uses feedback information from the deployed ML model 1230. The model inferencer 1308 implements the trained ML model 1230 to receive as input new unseen data, generate one or more inferences on the new data, and output a result such as an alert, a recommendation or other post-solution activity.

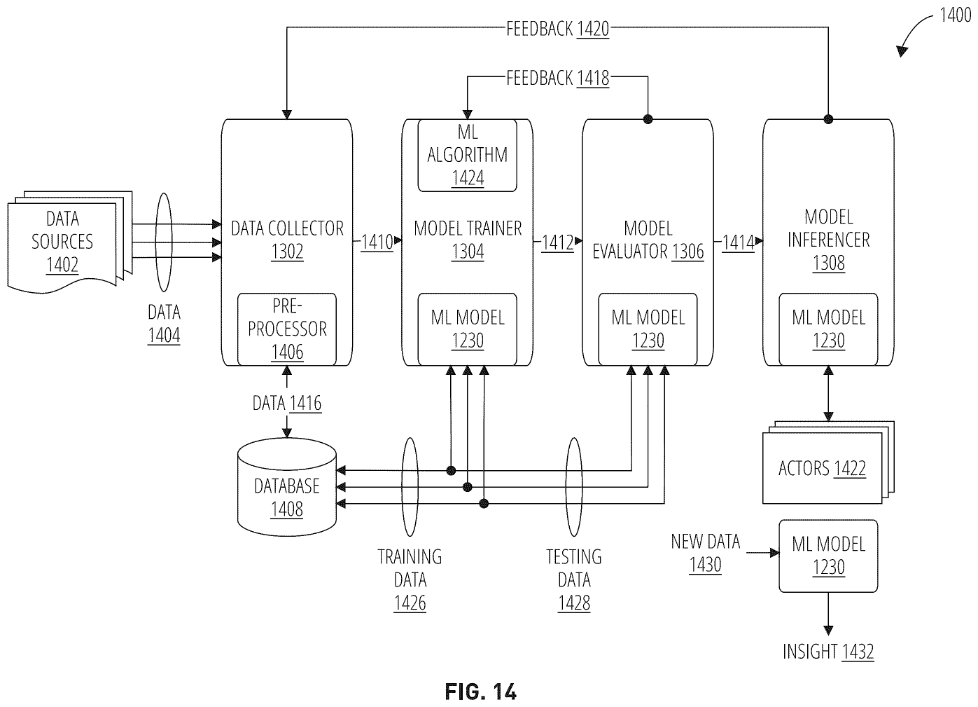

An exemplary AI/ML architecture for the ML components 1310 is described in more detail with reference to FIG. 14.

FIG. 14 illustrates an artificial intelligence architecture 1400 suitable for use by the training device 1314 to generate the ML model 1230 for deployment by the inferencing device 1204. The artificial intelligence architecture 1400 is an example of a system suitable for implementing various AI techniques and/or ML techniques to perform various inferencing tasks on behalf of the various devices of the system 1200.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1400 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1230, evaluate performance of the trained ML model 1230, and deploy the tested ML model 1230 as the trained ML model 1230 in a production environment, and continuously monitor and maintain it.

The ML model 1230 is a mathematical construct used to predict outcomes based on a set of input data. The ML model 1230 is trained using large volumes of training data 1426, and it can recognize patterns and trends in the training data 1426 to make accurate predictions. The ML model 1230 is derived from an ML algorithm 1424 (e.g., a neural network, decision tree, support vector machine, etc.). A data set is fed into the ML algorithm 1424 which trains an ML model 1230 to “learn” a function that produces mappings between a set of inputs and a set of outputs with a reasonably high accuracy. Given a sufficiently large enough set of inputs and outputs, the ML algorithm 1424 finds the function for a given task. This function can produce the correct output for input that it has not seen during training. A data scientist prepares the mappings, selects and tunes the ML algorithm 1424, and evaluates the resulting model performance. Once the ML logic 1228 is sufficiently accurate on test data, it can be deployed for production use.

The ML algorithm 1424 includes any ML algorithm suitable for a given AI task. Examples of ML algorithms includes supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1424 of the artificial intelligence architecture 1400 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 14, the artificial intelligence architecture 1400 includes a set of data sources 1402 to source data 1404 for the artificial intelligence architecture 1400. Data sources 1402 includes any device capable generating, processing, storing or managing data 1404 suitable for a ML system. Examples of data sources 1402 include without limitation databases, web scraping, sensors and Internet of Things (IoT) devices, image and video cameras, audio devices, text generators, publicly available databases, private databases, and many other data sources 1402. The data sources 1402 may be remote from the artificial intelligence architecture 1400 and accessed via a network, local to the artificial intelligence architecture 1400 an accessed via a network interface, or may be a combination of local and remote data sources 1402.

The data sources 1402 source difference types of data 1404. By way of example and not limitation, the data 1404 includes structured data from relational databases, such as customer profiles, transaction histories, or product inventories. The data 1404 includes unstructured data from websites such as customer reviews, news articles, social media posts, or product specifications. The data 1404 includes data from temperature sensors, motion detectors, and smart home appliances. The data 1404 includes image data from medical images, security footage, or satellite images. The data 1404 includes audio data from speech recognition, music recognition, or call centers. The data 1404 includes text data from emails, chat logs, customer feedback, news articles or social media posts. The data 1404 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1404 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1402 are communicatively coupled to a data collector 1302. The data collector 1302 gathers relevant data 1404 from the data sources 1402. Once collected, the data collector 1302 may use a pre-processor 1406 to make the data 1404 suitable for analysis. This involves data cleaning, transformation, and feature engineering. Data preprocessing is a critical step in ML as it directly impacts the accuracy and effectiveness of the ML model 1230. The pre-processor 1406 receives the data 1404 as input, processes the data 1404, and outputs pre-processed data 1416 for storage in a database 1408. Examples for the database 1408 includes a hard drive, solid state storage, and/or random access memory (RAM).

The data collector 1302 is communicatively coupled to a model trainer 1304. The model trainer 1304 performs AI/ML model training, validation, and testing which may generate model performance metrics as part of the model testing procedure. The model trainer 1304 receives the pre-processed data 1416 as input 1410 or via the database 1408. The model trainer 1304 implements a suitable ML algorithm 1424 to train an ML model 1230 on a set of training data 1426 from the pre-processed data 1416. The training process involves feeding the pre-processed data 1416 into the ML algorithm 1424 to produce or optimize an ML model 1230. The training process adjusts its parameters until it achieves an initial level of satisfactory performance.

The model trainer 1304 is communicatively coupled to a model evaluator 1306. After an ML model 1230 is trained, the ML model 1230 needs to be evaluated to assess its performance. This is done using various metrics such as accuracy, precision, recall, and F1 score. The model trainer 1304 outputs the ML model 1230, which is received as input 1410 or from the database 1408. The model evaluator 1306 receives the ML model 1230 as input 1412, and it initiates an evaluation process to measure performance of the ML model 1230. The evaluation process includes providing feedback 1418 to the model trainer 1304. The model trainer 1304 re-trains the ML model 1230 to improve performance in an iterative manner.

The model evaluator 1306 is communicatively coupled to a model inferencer 1308. The model inferencer 1308 provides AI/ML model inference output (e.g., inferences, predictions or decisions). Once the ML model 1230 is trained and evaluated, it is deployed in a production environment where it is used to make predictions on new data. The model inferencer 1308 receives the evaluated ML model 1230 as input 1414. The model inferencer 1308 uses the evaluated ML model 1230 to produce insights or predictions on real data, which is deployed as a final production ML model 1230. The inference output of the ML model 1230 is use case specific. The model inferencer 1308 also performs model monitoring and maintenance, which involves continuously monitoring performance of the ML model 1230 in the production environment and making any necessary updates or modifications to maintain its accuracy and effectiveness. The model inferencer 1308 provides feedback 1418 to the data collector 1302 to train or re-train the ML model 1230. The feedback 1418 includes model performance feedback information, which is used for monitoring and improving performance of the ML model 1230.

Some or all of the model inferencer 1308 is implemented by various actors 1422 in the artificial intelligence architecture 1400, including the ML model 1230 of the inferencing device 1204, for example. The actors 1422 use the deployed ML model 1230 on new data to make inferences or predictions for a given task, and output an insight 1432. The actors 1422 implement the model inferencer 1308 locally, or remotely receives outputs from the model inferencer 1308 in a distributed computing manner. The actors 1422 trigger actions directed to other entities or to itself. The actors 1422 provide feedback 1420 to the data collector 1302 via the model inferencer 1308. The feedback 1420 comprise data needed to derive training data, inference data or to monitor the performance of the ML model 1230 and its impact to the network through updating of key performance indicators (KPIs) and performance counters.

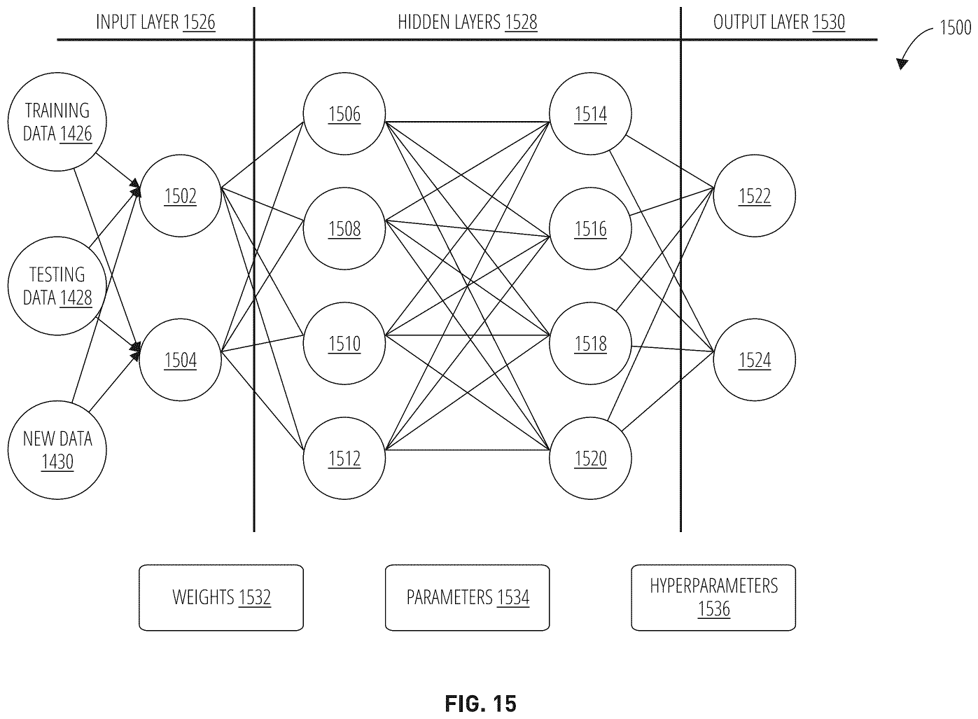

As previously described with reference to FIGS. 1, 2, the systems 1200, 1300 implement some or all of the artificial intelligence architecture 1400 to support various use cases and solutions for various AI/ML tasks. In various embodiments, the training device 1314 of the apparatus 1300 uses the artificial intelligence architecture 1400 to generate and train the ML model 1230 for use by the inferencing device 1204 for the system 1200. In one embodiment, for example, the training device 1314 may train the ML model 1230 as a neural network, as described in more detail with reference to FIG. 15. Other use cases and solutions for AI/ML are possible as well, and embodiments are not limited in this context.

FIG. 15 illustrates an embodiment of an artificial neural network 1500. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1500 comprises multiple node layers, containing an input layer 1526, one or more hidden layers 1528, and an output layer 1530. Each layer comprises one or more nodes, such as nodes 1502 to 1524. As depicted in FIG. 15, for example, the input layer 1526 has nodes 1502, 1504. The artificial neural network 1500 has two hidden layers 1528, with a first hidden layer having nodes 1506, 1508, 1510 and 1512, and a second hidden layer having nodes 1514, 1516, 1518 and 1520. The artificial neural network 1500 has an output layer 1530 with nodes 1522, 1524. Each node 1502 to 1524 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1500 relies on training data 1426 to learn and improve accuracy over time. However, once the the artificial neural network 1500 is fine-tuned for accuracy, and tested on testing data 1428, the artificial neural network 1500 is ready to classify and cluster new data 1430 at a high velocity. Tasks in speech recognition or image recognition can take minutes versus hours when compared to the manual identification by human experts.

Each individual node 1502 to 424 is a linear regression model, composed of input data, weights, a bias (or threshold), and an output. The linear regression model may have a formula similar to Equation (20), as follows:

$$\sum {w}_{i} {x}_{i} + bias = {w}_{1} {x}_{1} + {w}_{2} {x}_{2} + {w}_{3} {x}_{3} + bias output = f ( x ) = 1 if \sum {w}_{1} {x}_{1} + b >= 0 ; 0 if \sum {w}_{1} {x}_{1} + b < 0 \qquad EQUATION ( 20 )$$

Once an input layer 1526 is determined, a set of weights 1532 are assigned. The weights 1532 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1500 as a feedforward network.

In one embodiment, the artificial neural network 1500 leverages sigmoid neurons, which are distinguished by having values between 0 and 1. Since the artificial neural network 1500 behaves similarly to a decision tree, cascading data from one node to another, having x values between 0 and 1 will reduce the impact of any given change of a single variable on the output of any given node, and subsequently, the output of the artificial neural network 1500.

The artificial neural network 1500 has many practical use cases, like image recognition, speech recognition, text recognition or classification. The artificial neural network 1500 leverages supervised learning, or labeled datasets, to train the algorithm. As the model is trained, its accuracy is measured using a cost (or loss) function. This is also commonly referred to as the mean squared error (MSE). An example of a cost function is shown in Equation (21), as follows:

$$Cost Function = MSE = \frac{1}{2 m} {\sum }_{i = 1}^{m} {( - {y}_{i} )}^{2} \to MIN \qquad EQUATION ( 21 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1534 of the model adjust to gradually converge at the minimum.

In one embodiment, the artificial neural network 1500 is feedforward, meaning it flows in one direction only, from input to output. In one embodiment, the artificial neural network 1500 uses backpropagation. Backpropagation is when the artificial neural network 1500 moves in the opposite direction from output to input. Backpropagation allows calculation and attribution of errors associated with each neuron 1502 to 1524, thereby allowing adjustment to fit the parameters 1534 of the ML model 1230 appropriately.

The artificial neural network 1500 is implemented as different neural networks depending on a given task. Neural networks are classified into different types, which are used for different purposes. In one embodiment, the artificial neural network 1500 is implemented as a feedforward neural network, or multi-layer perceptrons (MLPs), comprised of an input layer 1526, hidden layers 1528, and an output layer 1530. While these neural networks are also commonly referred to as MLPs, they are actually comprised of sigmoid neurons, not perceptrons, as most real-world problems are nonlinear. Trained data 1404 usually is fed into these models to train them, and they are the foundation for computer vision, natural language processing, and other neural networks. In one embodiment, the artificial neural network 1500 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1500 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1500 is implemented as any type of neural network suitable for a given operational task of system 1200, and the MLP, CNN, GNN, HNN, HGNN, and RNN are merely a few examples. Embodiments are not limited in this context.

The artificial neural network 1500 includes a set of associated parameters 1534. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1500 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1536. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

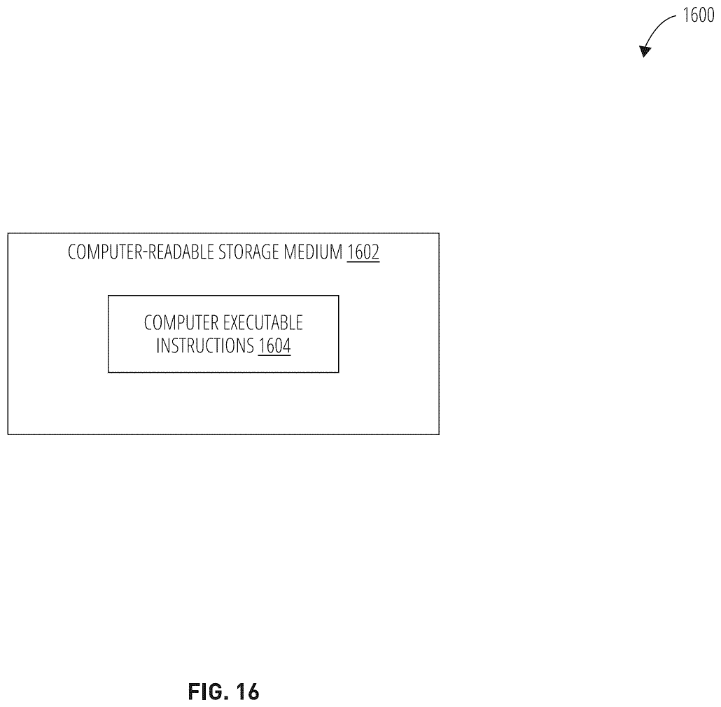

FIG. 16 illustrates an apparatus 1600. Apparatus 1600 comprises any non-transitory computer-readable storage medium 1602 or machine-readable storage medium, such as an optical, magnetic or semiconductor storage medium. In various embodiments, apparatus 1600 comprises an article of manufacture or a product. In some embodiments, the computer-readable storage medium 1602 stores computer executable instructions with which one or more processing devices or processing circuitry can execute. For example, computer executable instructions 1604 includes instructions to implement operations described with respect to any logic flows described herein. Examples of computer-readable storage medium 1602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1604 include any suitable type of code, such as source code, compiled code, interpreted code, executable code, static code, dynamic code, object-oriented code, visual code, and the like.

FIG. 17 illustrates an embodiment of a computing architecture 1700. Computing architecture 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1700 has a single processor with one core or more than one processor. Note that the term “processor” refers to a processor with a single core or a processor package with multiple processor cores. In at least one embodiment, the computing computing architecture 1700 is representative of the components of the system 1200. More generally, the computing computing architecture 1700 implements all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 17, computing architecture 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the computing architecture 1700 is another bus architecture, such as a multi-drop bus. Furthermore, each of processor 1704 and processor 1706 are processor packages with multiple processor cores including core(s) 1708 and core(s) 1710, respectively. While the computing architecture 1700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1704 and chipset 1732. Some platforms include additional components and some platforms include sockets to mount the processors and/or the chipset. Furthermore, some platforms do not have sockets (e.g. SoC, or the like). Although depicted as a SoC 1702, one or more of the components of the SoC 1702 are included in a single die package, a multi-chip module (MCM), a multi-die package, a chiplet, a bridge, and/or an interposer. Therefore, embodiments are not limited to a SoC.

The processor 1704 and processor 1706 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (i.e., processor 1704 and processor 1706). In other embodiments, the main memory couple with the processors via a bus and shared memory hub. Processor 1704 includes registers 1712 and processor 1706 includes registers 1714.

Computing architecture 1700 includes chipset 1732 coupled to processor 1704 and processor 1706. Furthermore, chipset 1732 are coupled to storage device 1750, for example, via an interface (I/F) 1738. The I/F 1738 may be, for example, a Peripheral Component Interconnect-enhanced (PCIe) interface, a Compute Express Link® (CXL) interface, or a Universal Chiplet Interconnect Express (UCIe) interface. Storage device 1750 stores instructions executable by circuitry of computing architecture 1700 (e.g., processor 1704, processor 1706, GPU 1748, accelerator 1754, vision processing unit 1756, or the like). For example, storage device 1750 can store instructions for the client device 1202, the client device 1206, the inferencing device 1204, the training device 1314, or the like.

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 couple the P2P interface 1728 and the P2P 1734 and the P2P interface 1730 and P2P 1736, respectively. DMI 1776 and DMI 1778 is a high-speed interconnect that facilitates, e.g., eight Giga Transfers per second (GT/s) such as DMI 3.0. In other embodiments, the processor 1704 and processor 1706 interconnect via a bus.

The chipset 1732 comprises a controller hub such as a platform controller hub (PCH). The chipset 1732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 comprises more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code. The I/F 1742 may also be coupled to a network interface circuit (NIC) 1780 for connections off-chip.

Furthermore, chipset 1732 includes the I/F 1738 to couple chipset 1732 with a high-performance graphics engine, such as, graphics processing circuitry or a graphics processing unit (GPU) 1748. In other embodiments, the computing architecture 1700 includes a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The computing architecture 1700 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1754 and/or vision processing unit 1756 are coupled to chipset 1732 via I/F 1738. The accelerator 1754 is representative of any type of accelerator device (e.g., a data streaming accelerator, cryptographic accelerator, cryptographic co-processor, an offload engine, etc.). One example of an accelerator 1754 is the Intel® Data Streaming Accelerator (DSA). The accelerator 1754 is a device including circuitry to accelerate copy operations, data encryption, hash value computation, data comparison operations (including comparison of data in memory 1716 and/or memory 1718), and/or data compression. Examples for the accelerator 1754 include a USB device, PCI device, PCIe device, CXL device, UCIe device, and/or an SPI device. The accelerator 1754 also includes circuitry arranged to execute machine learning (ML) related operations (e.g., training, inference, etc.) for ML models. Generally, the accelerator 1754 is specially designed to perform computationally intensive operations, such as hash value computations, comparison operations, cryptographic operations, and/or compression operations, in a manner that is more efficient than when performed by the processor 1704 or processor 1706. Because the load of the computing architecture 1700 includes hash value computations, comparison operations, cryptographic operations, and/or compression operations, the accelerator 1754 greatly increases performance of the computing architecture 1700 for these operations.

The accelerator 1754 includes one or more dedicated work queues and one or more shared work queues (each not pictured). Generally, a shared work queue is stores descriptors submitted by multiple software entities. The software is any type of executable code, such as a process, a thread, an application, a virtual machine, a container, a microservice, etc., that share the accelerator 1754. For example, the accelerator 1754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1754 via a non-posted write (e.g., a deferred memory write (DMWr)). One example of an instruction that atomically submits a work descriptor to the shared work queue of the accelerator 1754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1754. The dedicated work queue may accept job submissions via commands such as the movdir64b instruction.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 is a low pin count (LPC) bus. Various input/output (I/O) devices couple to the second bus 1774 including, for example, a keyboard 1762, a mouse 1764 and communication devices 1766.

Furthermore, an audio I/O 1768 couples to second bus 1774. Many of the I/O devices 1760 and communication devices 1766 reside on the system-on-chip (SoC) 1702 while the keyboard 1762 and the mouse 1764 are add-on peripherals. In other embodiments, some or all the I/O devices 1760 and communication devices 1766 are add-on peripherals and do not reside on the system-on-chip (SoC) 1702.

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, power supplies, and so forth. The embodiments, however, are not limited to implementation by the communications architecture 1800.

As shown in FIG. 18, the communications architecture 1800 includes one or more clients 1802 and servers 1804. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 communicate information between each other using a communication framework 1806. The communication framework 1806 implements any well-known communications techniques and protocols. The communication framework 1806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1802 and the servers 1804. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, crasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B. then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

What is claimed is:

1. A computer-implemented method, comprising:
determining, via a model module, a hypergraph model trained on a corpus of hypertext markup language (HTML) documents, wherein the hypergraph model comprises nodes and hyperedges, and each node corresponds to a style element of a plurality of style elements and each hyperedge corresponds to one of a plurality of fragments in the HTML documents;
identifying, via a style suggestion module, one or more candidate style elements for a candidate fragment of an HTML document;
selecting, by the style suggestion module, one of the one or more candidate styles elements;
determining, by the style suggestion module, the candidate fragment with a candidate style element of the one or more candidate style elements having a highest score by scoring the candidate fragment with each of the one or more candidate style elements utilizing embeddings of the hypergraph model; and
presenting, by the presentation module, the candidate fragment with the style element having the highest score.

2. The computer-implemented method of claim 1, wherein the one or more candidate style elements comprise at least one style element having a node in the hypergraph.

3. The computer-implemented method of claim 1, wherein the one or more candidate style element comprise at least one style element not represented in the hypergraph.

4. The computer-implemented method of claim 1, wherein scoring the candidate fragment comprises applying a mean cosine similarity function to the candidate fragment with the one of the one or more candidate style elements.

5. The computer-implemented method of claim 1, wherein scoring the candidate fragment comprises determining a maximum value and a minimum value across nodes of the candidate fragment with the one or more candidate style elements.

6. The computer-implemented method of claim 1, comprising generating, via the hypergraph generation module, the hypergraph model with the corpus of HTML documents, the HTML documents comprising electronic mail, webpages, slides, posters, or any combination thereof.

7. The computer-implemented method of claim 6, wherein generating the hypergraph model comprises:
determining, by an extraction module, the plurality of fragments and style elements for each of the one or more HTML documents, wherein each fragment comprises one or more of the style elements; and
generating, by a graph generation module, hyperedges for the fragments and nodes for style elements, wherein each of the plurality of fragments is represented by a corresponding hyperedge and each corresponding hyperedge couples the nodes for each of the one or more of the style elements of a particular fragment.

8. The computer-implemented method of claim 1, wherein each node is one of a plurality of node types comprising a button style, a text-style, a word, a background-font, a background-style, an image, fragment, or a fragment edge.

9. The computer-implemented method of claim 1, wherein at least a portion of the nodes represent fragment edges, and each node representing one of the fragment edges of a particular fragment is part of a hyperedge of at least one border fragment of the particular fragment.

10. The computer-implemented method of claim 1, wherein each hyperedge for a particular fragment includes a node for the particular fragment.

11. The computer-implemented method of claim 7, comprising identifying, by the extraction module, each of the plurality of fragments by an associated div tag.

12. The computer-implemented method of claim 7, comprising identifying, by the extraction module, each of the plurality of fragments using edge detection techniques on the HTML documents.

13. A non-transitory computer-readable storage medium, the computer-readable storage medium including instructions that when executed by one or more processors, cause the one or more processors to perform the operations of:
identify a hypergraph trained a corpus of hypertext markup language (HTML) documents, wherein the hypergraph comprises nodes and hyperedges, wherein each node corresponds to one style element of a plurality of style elements and each hyperedge corresponds to one fragment of a plurality of fragments in the HTML documents;
identify one or more candidate fragments for an HTML document, each of the one or more candidate fragments comprising a respective plurality of style elements;
score each of the one or more candidate fragments; and
select and present at least one of the one or more candidate fragments based on the scoring.

14. The computer-readable storage medium of claim 13, wherein each of the one or more candidate fragments is automatically generated based on the hypergraph.

15. The computer-readable storage medium of claim 13, wherein the operation to score each of the one or more candidate fragments includes applying a mean cosine similarity function to each of the one or more candidate fragments and at least one of the plurality of fragments represented in the hypergraph.

16. The computer-readable storage medium of claim 13, wherein the operation to score each of the candidate fragments includes determining a maximum value and a minimum value across nodes of each of the candidate fragments.

17. A system comprising:
a memory component; and
one or more processing devices coupled to the memory component, the one or more processing devices to perform operations comprising:
determine a corpus of hypertext markup language (HTML) documents comprising fragments and style elements, wherein the style element comprise text style elements and graphic style elements;
perform an extraction of each of the fragments and each of the style elements from each of the HTML documents;
determine hyperedges for the fragments and nodes for the style elements, wherein each of the fragments is represented by a corresponding hyperedge and each corresponding hyperedge includes one or more of the nodes for each of the style elements of a particular fragment.
identify relationships between each of the style elements and each of the fragments, wherein at least one relationship exists if a particular fragment includes a particular style element; and
store the relationships as vector representations in a data store.

18. The system of claim 17, the one or more processing devices further configured to perform the operations comprising:
determine the vector representations indicating the relationships among style elements and the fragments of HTML documents; and
store a first indicator in a matrix of the vector representations if a relationship exists between a style element and a fragment; or
store a second indicator in the matrix of the vector representations if a relationship does not exist between a style element and a fragment.

19. The system of claim 18, the one or more processing device further configured to perform the operations comprising:
generate a node for each of the fragments; and
store the first indicator in the matrix of the vector representations for a node representing a neighboring fragment of another fragment.

20. The system of claim 17, the one or more processing devices further configured to perform the operations comprising:
train a model with the vector representations, further comprising:
initialize node embeddings and hyperedge embeddings of the vector representations;
process the vector representations through one or more hyperedge convolution layers and one or more hypernode convolution layers until convergence to generate weighted vector representations; and
perform optimization on the weighted vector representations.
